(19) United States
(12) Patent Application Publication
(10) Pub. No.: US 2017/0322396 A1
(43) Pub. Date: Nov. 9, 2017

(54) COMPACT CAMERA DESIGN TO ADJUST PARALLAX EFFECTS

(71) Applicant: VideoStitch Inc., San Francisco, CA (US)

(72) Inventors: Nicolas Burtey, Mountain View, CA (US); Alexander Fink, San Jose, CA (US); Stéphane Valente, Paris (FR)

(21) Appl. No.: 15/148,044

(22) Filed: May 6, 2016

(51) Int. Cl. G02B 13/06; G02B 27/22; G02B 7/02; G03B 37/04

(52) U.S. Cl. CPC G02B 13/06; G03B 37/04; G02B 7/021; G02B 7/023; G02B 27/2214

(57) ABSTRACT

An apparatus comprising a plurality of lenses and a frame. The lenses may be arranged to provide coverage for a spherical field of view of a scene surrounding the apparatus. The frame may be configured to hold (A) a first subset of the lenses, (B) a second subset of the lenses and (C) a third subset of the lenses. At least one of the lenses in the first subset and at least one of the lenses in the second subset may be neighboring lenses arranged around a periphery of the apparatus. At least one of the lenses in the third subset and at least one of the lenses in the first subset or the second subset may be neighboring lenses. At least two of the neighboring lenses may be oriented to adjust parallax effects for a pre-determined purpose when the spherical field of view is recorded.

### FIELD OF THE INVENTION

The invention relates to an optical assembly generally and, more particularly, to a method and/or apparatus for implementing a compact camera design to adjust parallax effects.

### BACKGROUND

Conventional omnidirectional cameras (also known as virtual reality cameras, spherical cameras, panorama cameras, immersive video cameras, or 360 degree cameras) present design challenges. The purpose of omnidirectional cameras is to capture video in all directions surrounding the camera (i.e., 360 degrees in each axis). The video captured represents a complete view of a scene surrounding the person watching the video. A user typically uses a head-mounted display or an interactive video player to view the captured video on playback. The video orientation can be changed in any direction during playback.

The video provides the user with a spherical field of view of the scene surrounding the omnidirectional camera. A single lens cannot capture an entire spherical field of view. Conventional solutions include placing a convex mirror in front of the camera lens or capturing images from multiple lenses for several separate video signals. Using a mirror only provides a 360 degree horizontal coverage, while losing the top and bottom of the spherical field of view. When using multiple lenses, the multiple images are stitched together into a 360 degree intermediate representation. The multiple images need to have sufficient overlap so that overlapping areas can be blended together to offer a continuous and smooth representation of the scene surrounding the camera.

When multiple images are stitched together, the parallax of objects viewed by different cameras can create artifacts on the blended/overlapping areas. The parallax occurs because the objects are viewed differently (i.e., at different relative positions) by each camera. Blending artifacts are visible when viewing the spherical field of view and create a distraction from the user experience.

Theoretical solutions for reducing artifacts due to parallax effects may not be practical to implement. Physical space by camera lenses may restrict where a center of projection (e.g., a focal point, an optical center point and/or convergence point) for each camera can be located. Furthermore, in some applications, parallax effects may be useful. Eliminating parallax effects may not create a desired visual effect for the user in every implementation.

It would be desirable to implement a compact camera design to adjust parallax effects.

### SUMMARY

The invention concerns an apparatus comprising a plurality of lenses and a frame. The lenses may be arranged to provide coverage for a spherical field of view of a scene surrounding the apparatus. The frame may be configured to hold (A) a first subset of the lenses, (B) a second subset of the lenses and (C) a third subset of the lenses. At least one of the lenses in the first subset and at least one of the lenses in the second subset may be neighboring lenses arranged around a periphery of the apparatus. At least one of the lenses in the third subset and at least one of the lenses in the first subset or the second subset may be neighboring lenses. At least two of the neighboring lenses may be oriented to adjust parallax effects for a pre-determined purpose when the spherical field of view is recorded.

### BRIEF DESCRIPTION OF THE FIGURES

Embodiments of the invention will be apparent from the following detailed description and the appended claims and drawings in which:

FIG. 1 is a diagram illustrating an example embodiment of a camera;

FIG. 2 is a diagram of illustrating an isometric view of an arrangement of lenses of an omnidirectional camera;

FIG. 3 is a diagram illustrating a side view of an arrangement of lenses of an omnidirectional camera;

FIG. 4 is a diagram illustrating a top view of an arrangement of lenses of an omnidirectional camera;

FIG. 5 is a diagram illustrating an isometric view of an arrangement of lenses of an omnidirectional camera oriented to adjust parallax effects;

FIG. 6 is a diagram illustrating a side view of an arrangement of lenses of an omnidirectional camera oriented to adjust parallax effects;

FIG. 7 is a diagram illustrating a top view of an arrangement of lenses of an omnidirectional camera oriented to adjust parallax effects;

FIG. 8 is a diagram illustrating an isometric view of circuit board placement for an example embodiment of an omnidirectional camera;

FIG. 9 is a diagram illustrating a side view of circuit board placement for an example embodiment of an omnidirectional camera;

FIG. 10 is a diagram illustrating a top view of circuit board placement for an example embodiment of an omnidirectional camera;

FIG. 11 is a diagram illustrating an isometric view of lenses passing through a circuit board hole;

FIG. 12 is a diagram illustrating a side view of lenses passing through a circuit board hole;

FIG. 13 is a diagram illustrating a top view of lenses passing through a circuit board hole;

FIG. 14 is a diagram illustrating an isometric view of an example embodiment with all lenses around a periphery of an omnidirectional camera;

FIG. 15 is a diagram illustrating a side view of an example embodiment with all lenses around a periphery of an omnidirectional camera;

FIG. 16 is a diagram illustrating a top view of an example embodiment with all lenses around a periphery of an omnidirectional camera;

FIG. 17 is a diagram illustrating an isometric view of an example embodiment with all lenses around a periphery of an omnidirectional camera and oriented to adjust parallax effects;

FIG. 18 is a diagram illustrating a side view of an example embodiment with all lenses around a periphery of an omnidirectional camera and oriented to adjust parallax effects;

FIG. 19 is a diagram illustrating a top view of an example embodiment with all lenses around a periphery of an omnidirectional camera and oriented to adjust parallax effects;

FIG. 20 is a diagram illustrating an example embodiment having six lenses around a periphery and two vertically oriented lenses;

FIG. 21 is a diagram illustrating an example embodiment having six lenses around a periphery and two vertically oriented lenses passing through a hole of a circuit board;

FIG. 22 is a diagram illustrating an example embodiment with eight lenses arranged around a periphery of an omnidirectional camera;

FIG. 23 is a diagram illustrating an example embodiment with eight lenses arranged around a periphery of an omnidirectional camera oriented to adjust parallax effects;

FIG. 24 is a diagram illustrating an example embodiment with eight lenses arranged around a periphery of an omnidirectional camera oriented to adjust parallax effects and two vertically oriented lenses; and

FIG. 25 is a diagram illustrating an example embodiment with eight lenses arranged around a periphery of an omnidirectional camera oriented to adjust parallax effects and two vertically oriented lenses passing through holes of circuit boards.

### DETAILED DESCRIPTION OF THE EMBODIMENTS

Embodiments of the present invention include providing a compact camera design that may (i) limit a size of an omnidirectional camera, (ii) capture images to provide coverage for a spherical field of view, (iii) reduce artifacts when video stitching operations are performed, (iv) control artifacts created when video stitching operations are performed, (v) be configured to accommodate video capture electronics, (vi) be scaled up as a number of lenses is increased and/or (vii) be implemented as one or more integrated circuits.

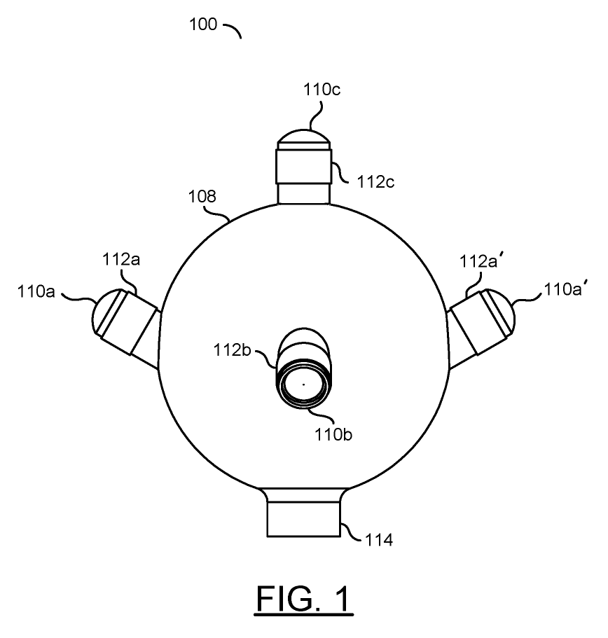

Referring to FIG. 1, a diagram illustrating an example embodiment of a camera 100 is shown. The camera 100 may be configured as an omnidirectional camera. The omnidirectional camera 100 may be implemented as a virtual reality camera, a spherical camera, a panorama camera, an immersive video cameras, a 360 degree camera, etc. Generally, the omnidirectional camera 100 comprises multiple image capturing sensors. The omnidirectional camera 100 may be configured to capture still and/or moving images (e.g., record video). The images captured by the multiple sensors of the omnidirectional camera 100 may be used for video stitching operations to generate a spherical field of view. In some embodiments, the video stitching operations may be performed by the omnidirectional camera 100 (e.g., video stitching performed locally). In some embodiments, the video stitching operations may be performed by an external computing device (e.g., a connection from the omnidirectional camera 100 to an external device such as a micro computer may be implemented).

The omnidirectional camera 100 may comprise a frame 108, multiple lenses 110, multiple lens barrels 112 and/or a mount 114. The omnidirectional camera 100 may be implemented to capture the spherical field of view while maintaining a compact size. For example, the omnidirectional camera 100 may be designed to be a portable camera (e.g., easy for one person to carry). The omnidirectional camera 100 is shown having a spherical shape. The size, shape and/or style of the omnidirectional camera 100 may be varied according to the design criteria of a particular implementation.

The frame 108 may be configured to hold the lenses 110 and/or the lens barrels 112. The frame 108 may provide a support structure and/or protection for the various components of the omnidirectional camera 100. The frame 108 is shown having a spherical shape. The spherical shape of the frame 108 may reduce a size of the omnidirectional camera 100. In some embodiments, the frame 108 may be a square and/or rectangular shape. In some embodiments, the frame 108 may have a contoured shape. The size of the frame 108 may be selected to accommodate a number and/or an entanglement (e.g., arrangement) of the lens barrels 112. In some embodiments, the frame 108 may be manufactured as a single piece. In some embodiments, the frame 108 may comprise an assembly of multiple components. The shape and/or size of the frame 108 may be varied according to the design criteria of a particular implementation.

The lenses 110 may be camera lenses. For example, the lenses 110 may focus light through the corresponding lens barrels 112 onto a respective image sensor to capture images. The lenses 110 may be implemented as wide angle lenses. The lenses 110 may be arranged around the frame 108 in order to capture the environment surrounding the omnidirectional camera 100 in all directions.

The lenses 110 may comprise various subsets of the lenses 110. In an example, one subset of the lenses 110 may be the lenses 110a-110a′. In another example, one subset of the lenses 110 may be the lenses 110b-110b′ (e.g., the lens 110b′ may be on a backside of the omnidirectional camera 100). In yet another example, one subset of the lenses 110 may be the lens 110c. In some embodiments, the various subsets of lenses 110 may comprise one, two, or more of the lenses 110. In some embodiments, the various subsets of the lenses 110 may be configured as opposite lens pairs. In an example, the subset of lenses 110a-110a′ may be an opposite lens pair (e.g., the lens 110a is on a left side of the omnidirectional camera 100 and the lens 110a′ is on a right side of the omnidirectional camera 100). In another example, the subset of lenses 110b-110b′ may be an opposite lens pair (e.g., the lens 110b is on a front side of the omnidirectional camera 100 and the lens 110b′ is on a back side of the omnidirectional camera 100). In an example, one of the subsets of the lenses 110 may comprise a single lens (e.g., the lens 110c). The arrangement of the subsets of the lenses 110 may be varied according to the design criteria of a particular implementation.

Some of the lenses 110 may be neighboring lenses. The neighboring lenses may be two or more of the lenses 110 that are adjacent to each other. In an example, the lenses 110a and 110b may be neighboring lenses. In another example, the lenses 110b and 110a′ may be neighboring lenses. In yet another example, the lenses 110a and 110c may be neighboring lenses, the lenses 110b and 110c may be neighboring lenses and the lenses 110a′ and 110c may be neighboring lenses. Generally, the opposite lens pairs may not be neighboring lenses (e.g., the opposite lens pairs have one or more of the lenses 110 located in between). For example, the opposite lens pair 110a-110a′ may not be neighboring lenses because the lens 110b (or 110b′, or 110c) is in between the lenses 110a and 110a′. Some of the lenses 110 may be considered horizontally neighboring. For example, in the orientation shown, the lens 110a and 110b may be horizontally neighboring lenses. Some of the lenses 110 may be considered vertically neighboring. In the orientation shown, the lens 110a and 110c may be vertically neighboring lenses. Each of the lenses 110 are shown attached to a respective lens barrel 112. For example, the lens 110a is shown connected to the lens barrel 112a, the lens 110a′ is shown connected to the lens barrel 112a′, the lens 110b is shown connected to the lens barrel 112b, the lens 110c is shown connected to the lens barrel 112c, etc. The various lens barrels 112 may be configured to direct (e.g., aim), provide a focus and/or provide a zoom for the lenses 110. Some of the lens barrels 112 are shown tilted. For example, the lens barrels 112a-112a′ are shown tilted upwards and the lens barrel 112b is shown tilted downwards. The lens barrels 112 may be tilted to control parallax effects. Generally, the arrangement of the lens barrels 112 corresponding to the horizontally neighboring lenses (e.g., 110a and 110b, 110b and 110a′, etc.) are oriented to be tilted in alternating directions around a periphery of the omnidirectional camera 100. Some of the lens barrels (e.g., 112c) are shown oriented in a straight direction. The lens barrels 112 may be arranged to provide full coverage for the spherical field of view. For example, the orientation of the lenses 110 and/or the lens barrels 112 may be arranged to adjust (or configure) the parallax effects (either upward or downward) for a pre-determined purpose while still providing coverage for the spherical field of view.

The lens barrels 112 may each be configured to focus light from the lenses 110 to image capture sensors within the omnidirectional camera 100. Each of the lens barrels 112 may direct incoming light to a respective image capture sensor. The lens barrels 112 may each be configured to extend and/or retract (e.g., to zoom in/out). Each of the lens barrels 112 may comprise a center of projection (e.g., a focal point, an optical center, etc.). The respective centers of projection may be located at some point within the lens barrels 112. A location of the centers of projection may be varied based on a size of the lens barrel 112 and/or characteristics of the lenses 110.

The mount 114 is shown on a bottom of the omnidirectional camera 100. The mount 114 may provide an interface (e.g., a mechanical interface) to attach a support structure (e.g., a tripod) for the omnidirectional camera 100. The type and/or location of the mount 114 may be varied according to the design criteria of a particular implementation.

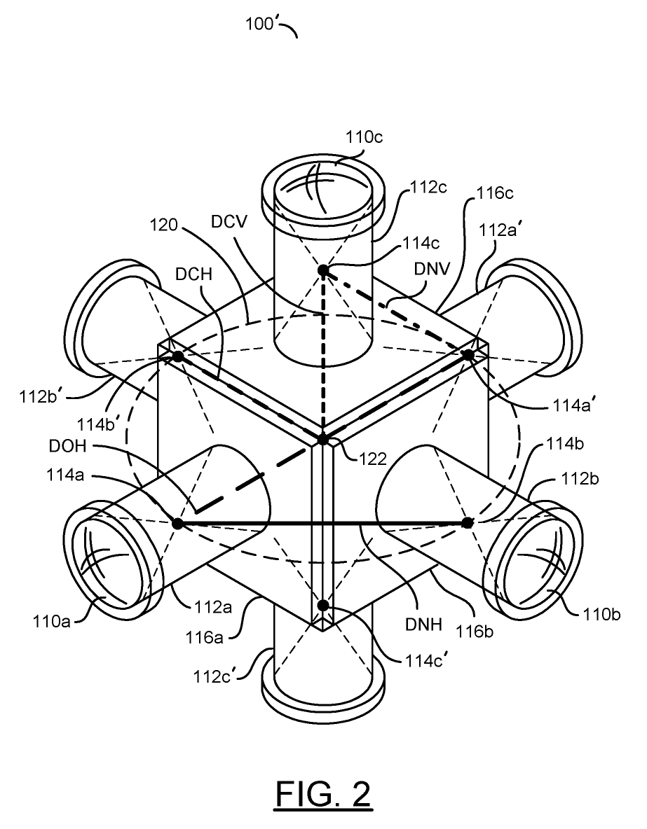

Referring to FIG. 2, a diagram illustrating an isometric view of an arrangement of the lenses 110 of an omnidirectional camera 100′ is shown. The omnidirectional camera 100′ may comprise 6 of the lenses 110. The lenses 110 may comprise 3 subsets (e.g., the subset of lenses 110a-110a′, the subset of lenses 110b-110b′ and the subset of lenses 110c-110c′). Each of the subset of lenses 110a-110a′, the subset of lenses 110b-110b′ and the subset of lenses 110c-110c′ may be arranged as opposite lens pairs.

The subset of lenses 110a-110a′ and 110b-110b′ are shown arranged around a periphery 120 of the omnidirectional camera 100′. In an example, the periphery 120 may represent a horizontal plane. Each of the lenses 110a, 110b, 110a′ and 110b′ may be aimed in different direction along the horizontal plane (e.g., arranged around the periphery 120) with respect to the omnidirectional camera 100′. The lenses 110 that are adjacent to each other and arranged around the periphery 120 may be considered horizontally neighboring lenses. For example, the lenses 110a and 110b′ may be horizontally neighboring lenses. The lenses 110 that are directed in opposite directions to each other and arranged around the periphery 120 may be considered horizontally opposite lenses. The horizontally opposite lenses may be directed in horizontally opposite directions (e.g., when projected onto a horizontal plane). The horizontally opposite lenses may be directly across from each other. In an example, the lenses 110b-110b′ may be horizontally opposite lenses.

The subset of lenses 110c-110c′ is shown as a vertically oriented lens pair (e.g., an opposite lens pair). The lens 110c is shown directed in one direction (e.g., an upward direction). The lens 110c′ is shown directed in another direction (e.g., a downward direction). The subset of lenses 110c-110c′ may comprise lenses 110 that are vertically neighboring to each of the lenses arranged around the periphery 120. In an example, the lens 110c may be vertically neighboring each of the lenses of the subset 110a-110a′ and each of the lenses of the subset 110b-110b′. In another example, the lens 110c′ may be vertically neighboring each of the lenses of the subset 110a-110a′ and each of the lenses of the subset 110b-110b′. The lenses 110c-110c′ may be vertically opposite lenses.

Each of the lenses 110 and the lens barrels 112 may have a corresponding center of projection 114. In the example shown, the center of projection 114a for the lens 110a is shown as a center point of the lens barrel 112a. In another example, the center of projection 114a may not be the center point of the lens barrel 112a. Similar centers of projection (e.g., 114a′, 114b, 114b′, 114c and/or 114c′) may correspond to the lenses 110a′, 110b, 110b′, 110c and/or 110c′. A particular location of the centers of projection 114 may be varied according to the design criteria of a particular implementation.

Each of the lenses 110 and the lens barrels 112 may be connected to a corresponding base 116. Each of the bases 116 may be part of a sensor-lens assembly (or module). Each of the bases 116 may provide structural support for the respective lens barrel 112 and contain the respective image sensors. A size of the bases 116 may be determined based on a size of the image sensors. For example, the base 116 may be a base a mount for the lens barrel 112. In another example, the base 116 may comprise a circuit board that the lens mount is attached to. In still another example, the base 116 may be an enclosure comprising the camera sensor and additional circuitry. In some embodiments, the bases 116 may be contained within the frame 108. In the example shown, each of the bases 116a, 116a′, 116b, 116b′, 116c and 116c′ are arranged edge-to-edge to create a cubic shape.

Locations for the centers of projection 114a, 114a′, 114b, 114b′, 114c and 114c′ may determine various optical properties of the spherical field of view captured by the omnidirectional camera 100′. Parallax effects may be created as a result of the locations of the centers of projection 114. In an example, distances between the centers of projection 114a, 114a′, 114b, 114b′, 114c and 114c′ may be selected to adjust (or configure) the parallax effects.

Each of the bases 116 may occupy an amount of space. The bases 116 may each have a thickness T. The bases 116 may each have a width B. For example, the bases 116 are shown having a square base (e.g., a height B and width B). Each of the bases 116 may have a height H measured from the back of the base 116 to the center of projection 114 of the lens barrel 112. The measurements T, B and H may be varied according to the design criteria of a particular implementation.

The lenses 110 and/or the lens barrels 112 may be oriented (e.g., entangled) to adjust the location of the centers of projection 114. The centers of projection 114 may be located based on a pre-determined purpose. In some embodiments, the distances between the centers of projection 114 may be selected to reduce (or eliminate) parallax effects. For example, if the pre-determined purpose for the omnidirectional camera 100′ is monoscopic rendering, the centers of projection 114 may be arranged to reduce the parallax effects (e.g., to reduce video stitching artifacts). In some embodiments, distances between the centers of projection 114 may be selected to produce various desired optical effects (e.g., to create 3D images). For example, if the pre-determined purpose for the omnidirectional camera 100′ is stereoscopic rendering, the centers of projection 114 may be arranged to produce a particular type (e.g., horizontal or vertical) and amount of parallax effects adapted to the human visual system (e.g., to take advantage of human visual biology). The type of parallax effects resulting from the locations of the centers of projection 114 may be varied according to the design criteria of a particular implementation and/or by adjusting the height of the lens barrels 112, the thickness T of the bases 116, the width B of the bases 116 and/or the orientation of the lenses 110 (e.g., an amount of tilt). A distance (e.g., DOH) is shown. The distance DOH may represent a distance between the centers of projection 114a and 114a′ of the horizontally opposite lens pair 110a-110a′. The distance DOH may be the same for the other horizontally opposite lens pair 110b-110b′. A distance (e.g., DNH) is shown. The distance DNH may represent a distance between the centers of projection 114a and 114b of the horizontally neighboring lenses 110a and 110b. The distance DNH may be the same for the other horizontally neighboring lenses (e.g., 110b and 110a′, 110b′ and 110a′, and 110b′ and 110a) arranged around the periphery 120 of the omnidirectional camera 100′. A distance (e.g., DCH) is shown. The distance DCH may represent a distance between the center of projection 114b′ of the lens 110b′ and a center point 122 of the omnidirectional camera 100′. The distance DCH may be the same for each of the lenses 110a, 110a′, 110b and 110b′ arranged around the periphery 120 with respect to the center point 122.

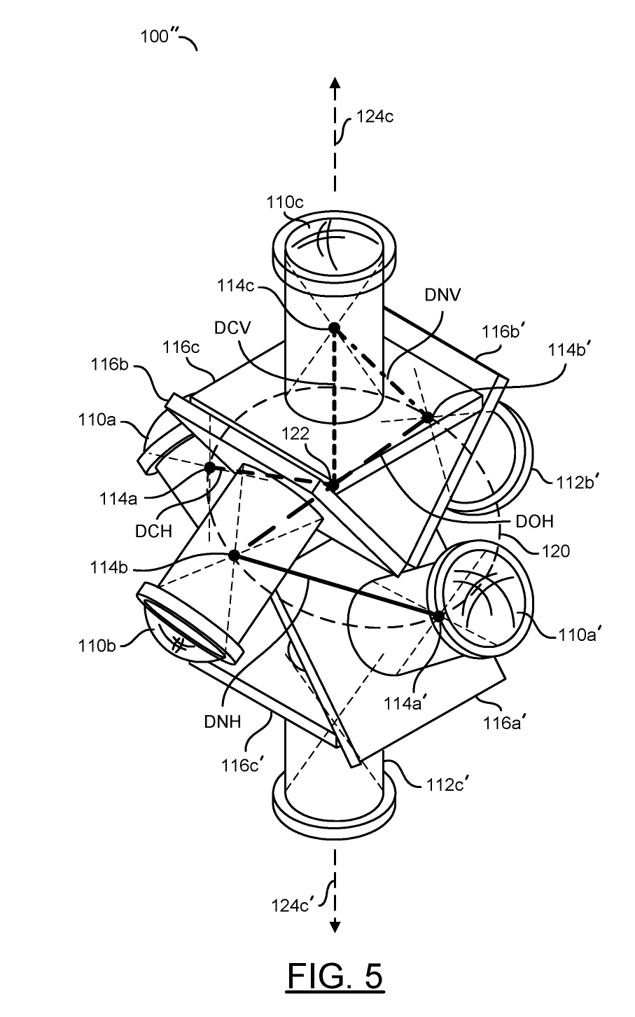

A distance (e.g., DNV) is shown. The distance DNV may represent a distance between the center of projection 114c and 114a′ of the vertically neighboring lenses 110c and 110a′. For example, the distance DNV may represent the distance between the center of projection 114 of one of the vertically oriented lenses (e.g., 110c or 110c′) and a nearest one of the horizontally oriented lenses (e.g., one of the lenses 110a, 110a′, 110b or 110b′) arranged around the periphery 120. In the embodiment shown in FIG. 2, each of the horizontally oriented lenses 110 arranged around the periphery 120 may be generally equidistant to the vertically oriented lenses (e.g., the lenses 110a, 110a′, 110b and/or 110b′ are shown not tilted). In some embodiments, one of the lenses 110 arranged around the periphery 120 may be nearest to one of the vertically oriented lenses as a result of tilting one or more of the lenses 110 arranged around the periphery 120 (to be described in more detail in association with FIG. 5). The distance DNV may be the same between each of the vertically neighboring lens pairs (e.g., the lens 110c and each of the lenses 110 arranged around the periphery 120 and the lens 110c′ and each of the lenses 110 arranged around the periphery 120). A distance (e.g., DCV) is shown. The distance DCV may represent a distance between the center of projection 114c of the lens 110c and the center point 122. The distance DCV may be the same for the lens 110c′ with respect to the center point 122 of the apparatus 100′.

In some embodiments, where the pre-determined purpose is a monoscopic rendering of the spherical video captured by the omnidirectional camera 100′, the lenses 110 and/or the lens barrels 112 may be arranged (e.g., oriented and/or entangled) to reduce (e.g., minimize) an amount of parallax between the lenses 110. To reduce the amount of parallax between the lenses 110 the orientation may be configured to reduce (e.g., minimize) distances (e.g., the distance DNH) between the optical centers 114 of the horizontally neighboring lenses (e.g., the adjacent lenses 110 around the periphery 120) and reduce the distance (e.g., the distance DNV) between the optical centers 114c and/or 114c′ of the top and/or bottom lenses 110c and/or 110c′ and the optical centers 114 of the horizontal lenses 110 arranged around the periphery 120. Reducing the distance DNH and the distance DNV may reduce stitching artefacts due to the parallax.

In some embodiments, where the pre-determined purpose is stereoscopic rendering of the spherical video captured by the omnidirectional camera 100′, the lenses 110 and/or the lens barrels 112 may be arranged (e.g., oriented and/or entangled) to control the parallax between the horizontal neighboring lenses 110 arranged around the periphery 120 (e.g., not only reduce parallax). Generally, for stereoscopic renderings two spherical videos may be stitched. One of the spherical videos may be implemented for the left eye of a user and another of the spherical videos may be implemented for the right eye of a user. The human brain may reconstruct a three-dimensional view if both spherical fields of view have parallax effects corresponding to parallax effects that occur with regular binocular human vision. For example, humans see in 3D because the eyes are a particular distance apart (e.g., approximately 6 centimeters apart from each other) and the human brain analyses the parallax due to the particular distance in both views. The stereoscopic rendering may be implemented to take advantage of human vision to provide a 3D view to the user. For stereoscopic renderings stitching artefacts may be present due to the parallax effects. The stitching artefacts may be a result of the parallax effects. In some embodiments implementing stereoscopy, there may be parallax effects without stitching artefacts.

The stereoscopic parallax effects may be reproduced by stitching the left view from pixels on the right hand side of the input horizontal images, and the right view from the pixels on the left side of the input horizontal images. Distances between the centers of projection 114 (e.g., optical center points) of the lenses 110 in one of the subsets of the lenses 110 and another of the subsets of the lenses 110 may be selected to implement a stereoscopic baseline. For example, if the horizontally neighboring lenses are placed approximately 6 cm apart from each other, then a 6 cm parallax effect may be present between the left and right views for stereoscopy.

Statements relating to “horizontal” and “vertical” are used as a reference. The orientation of the omnidirectional camera 100 may be changed. In one example orientation, the lenses 110a-110a′ may appear along a horizontal plane. In another example orientation, the lenses 110a-110a′ may appear along a vertical plane and/or any other plane. Generally, the lenses 110 arranged around the periphery 120 are referred to as the “horizontal lenses”. The lenses 110 arranged to be generally perpendicular to the periphery 120 are referred to as the “vertical lenses”. For clarity, references to the orientation (or tilting) of the lenses 110 may also include an orientation and/or tilt of the lens barrels 112, the base 116 and/or the image sensors. For example, one of the lenses 110, one of the lens barrels 112 and/or one of the bases 116 may comprise a capture device unit. The capture device unit may be directed (e.g., aimed, entangled, tilted, etc.) as one unit.

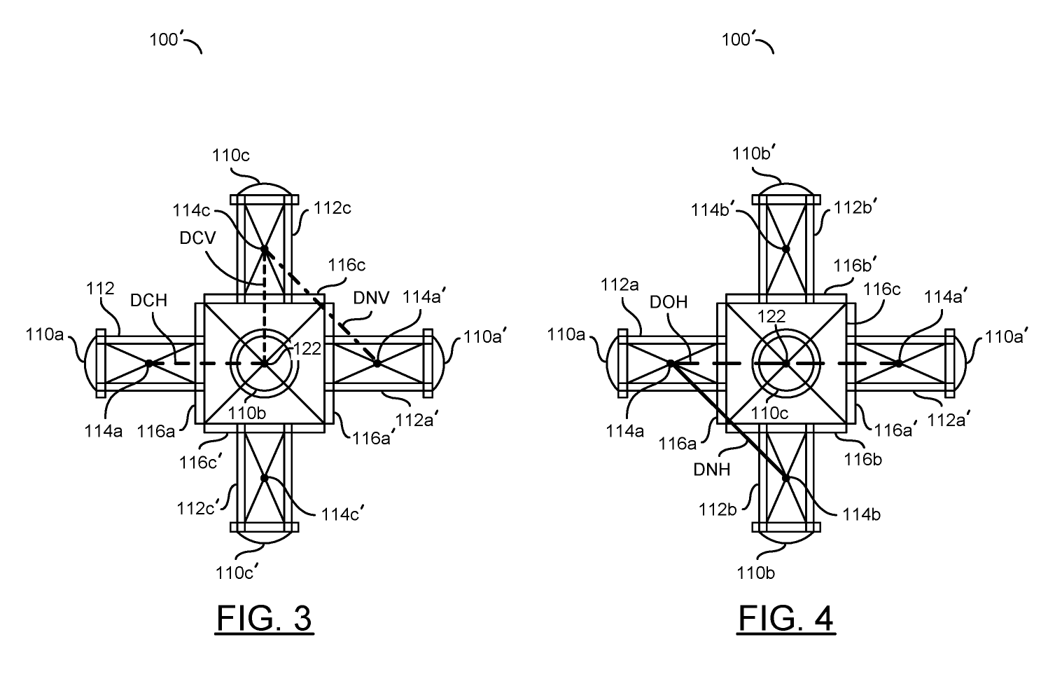

Referring to FIG. 3, a diagram illustrating a side view of an arrangement of the lenses 110 of the omnidirectional camera 100′ is shown. The side view of the omnidirectional camera 100′ shows the lenses 110a, 110b and 110a′ arranged around the periphery 120. The side view of the omnidirectional camera 100′ shows the lenses 110c and 110c′ each pointed in opposite directions and perpendicular to the lenses 110a, 110b and 110a′.

Referring to FIG. 4, a diagram of illustrating a top view of an arrangement of the lenses 110 of the omnidirectional camera 100′ is shown. The top view of the omnidirectional camera 100′ shows the lenses 110a, 110b, 110a′ and 110b′ arranged around the periphery 120 and each pointing in a different direction. The lens 110c is shown pointing in a direction perpendicular to the lenses 110a, 110b, 110a′ and 110b′.

The distance DNH is shown between the optical center 114a and the optical center 114b. Similarly, the distance DNH may be equal for each of the neighboring lenses 110 arranged around the periphery 120 (e.g., the horizontal plane). For the orientation of the omnidirectional camera 100′, the distance DNH may be calculated using an equation EQ 1:

D_{NH}+{square root over ((H+B/2)²+((H+B/2)sin(π/2))²)}=(H+B/2)

The distance DCH is shown between the center of projection 114a and the center point 122 (e.g., the center of the lens rig). Similarly, the distance DCH may be equal for each of the lenses 110 arranged around the periphery 120. For the orientation of the omnidirectional camera 100′, the distance DNH may be calculated using an equation EQ 2:

D_{CH}=H+B/2

The distance DOH is shown between the center of projection 114a and the center of projection 114a′. Similarly, the distance DOH may be equal for each of the opposite lens pairs 110a-110a′ and 110b-110b′ arranged around the periphery 120. For the orientation of the omnidirectional camera 100′, the distance DOH may be calculated using an equation EQ 3:

D_{OH}=2D_{CH}=2H+B

The distance DCV is shown between the center of projection 114c and the center point 122 of the lens rig. Similarly, the distance DCV may be equal for the lens 110c′. For the orientation of the omnidirectional camera 100′, the distance DCV may be calculated using an equation EQ 4:

D_{CV}=H+B/2

The distance DNV is shown between the centers of projection 114c and 114a′. The distance DCV may be calculated using an equation EQ 5:

D_{NV}=\sqrt{2(H+B/2)²}

The equations used to calculate the distances DNH, DCH and DOH may be generalized as more of the lenses 110 are added around the periphery 120 of the omnidirectional camera 100. For example, a size of the omnidirectional camera 100 may be scaled up to accommodate a greater number of the lenses 110. Where N represents the number of the lenses 110 arranged around the periphery 120 and the lenses 110 are not tilted, the distance DNH may be calculated using an equation EQ 6:

$${D}_{NH} = \frac{B}{2 tan ( π / N ) )} \sqrt{{( 1 - cos ( 2 π / N ) )}^{2} + {sin ( 2 π / N )}^{2}}$$

For N of the lenses 110 arranged around the periphery 120 and when the lenses 110 are not tilted, the distance DCH may be calculated using an equation EQ 7:

$${D}_{CH} = \frac{B}{2 tan ( π / N ) )} + H$$

For N of the lenses 110 arranged around the periphery 120 and when the lenses 110 are not tilted, the distance DOH may be calculated using an equation EQ 8:

$${D}_{OH} = 2 {D}_{CH} = \frac{B}{tan ( π / N )} + 2 H$$

In the example shown in FIGS. 2-4, the number of lenses arranged around the periphery 120 may be 4 (e.g., the lenses 110a, 110a′, 110b and 110b′). For an example, where H=20 mm, B=25 mm and T=5 mm, the distance DNH=46 mm, the distance DCH=32.5 mm, the distance DOH=65 mm, and the distance DNV=46 mm.

In the example embodiment of the omnidirectional camera 100′, the lenses 110 are shown without tilting. By tilting and/or entangling the lenses 110 arranged around the periphery 120 the centers of projection 114 may be brought closer together compared to what the distances would be when the lenses 110 are untilted (e.g., strictly on the horizontal plane). Furthermore, additional lenses 110 may be added around the periphery 120 to provide additional coverage for the spherical field of view. Another subset of lenses (e.g., the lenses 110c and 110c′) may optionally be added to the omnidirectional camera 100′ to be directed towards points of interest in each configuration.

Referring to FIG. 5, a diagram illustrating an isometric view of an arrangement of the lenses 110 of an omnidirectional camera 100″ oriented to adjust (or configure) parallax effects is shown. The lenses 110a, 110a′, 110b and 110b′ are shown arranged around the periphery 120 of the omnidirectional camera 100″. The lens 110c is shown on a top side of the omnidirectional camera 100″. The lens 110c′ is shown on the bottom side of the omnidirectional camera 100″.

The lenses 110 arranged around the periphery 120 (e.g., 110a, 110b, 110a′, 110b′) and/or the lens barrels 112 are shown alternately tilting in different directions (e.g., the horizontally neighboring lenses 110 are alternately tilting in different directions). In the embodiment shown, with 4 of the lenses 110 around the periphery 120, the horizontally opposite lenses may point in opposite directions when projected onto a horizontal plane. The opposite lens pair 110a-110a′ are shown tilted upwards (e.g., towards a direction 124c). The opposite lens pair 110b-110b′ are shown tilted downwards (e.g., towards a direction 124c′). The direction 124c is shown pointing above the omnidirectional camera 100″. In the example shown, the direction 124c may be the optical axis of the lens 110c. In an example, the direction 124c may not be the optical axis of the lens 110c (e.g., the optical axis of the lens 110c and the direction 124c may be different directions). The direction 124c′ is shown pointing below the omnidirectional camera 100″. In the example shown, the direction 124c′ may be the optical axis of the lens 110c′. In an example, the direction 124c′ may not be the optical axis of the lens 110c′ (e.g., the optical axis of the lens 110c′ and the direction 124c′ may be different directions).

In the example shown, the lenses 110c and 110c′ are shown not tilted. In some embodiments, the lenses 110c and/or 110c′ may be tilted. For example, the lenses 110c and/or 110c′ may be tilted to capture particular areas of interest.

The distance DCV is shown between the center of projection 114c and the center point 122. The distance DNV is shown between the center of projection 114c and the center of projection 114b′. In some embodiments (e.g., depending on an amount of tilt of each of the lenses 110), the distance DNV may be different for each of the lenses 110 (e.g., the distance DNV between the centers of projection 114c and 114b′ may be different from the centers of projection 114c and 114b). The distance DCH is shown between the center of projection 114a and the center point 122. In some embodiments (e.g., depending on the amount of tilt of the lenses 110), the distance DCH may be different for each of the lenses 110 around the periphery 120 (e.g., the distance DCH between the center of projection 114a and the center point 122 may be different from the distance DCH between center of projection 114a′ and the center point 122).

The distance DNH is shown between the center of projection 114b and the center of projection 114a′. In some embodiments (e.g., depending on the amount of tilt of the lenses 110), the distance DNH may be different for each of the lenses 110 around the periphery 120 (e.g., the distance DNH between the center of projection 114b and the center of projection 114a′ may be different from the distance DNH between center of projection 114b and the center of projection 114a). The distance DOH is shown between the center of projection 114b and the center of projection 114b′. In some embodiments (e.g., depending on the amount of tilt of the lenses 110), the distance DOH may be different for each of the lenses 110 around the periphery 120 (e.g., the distance DOH between the center of projection 114a and the center of projection 114a′ may be different from the distance DOH between center of projection 114b and the center of projection 114b′).

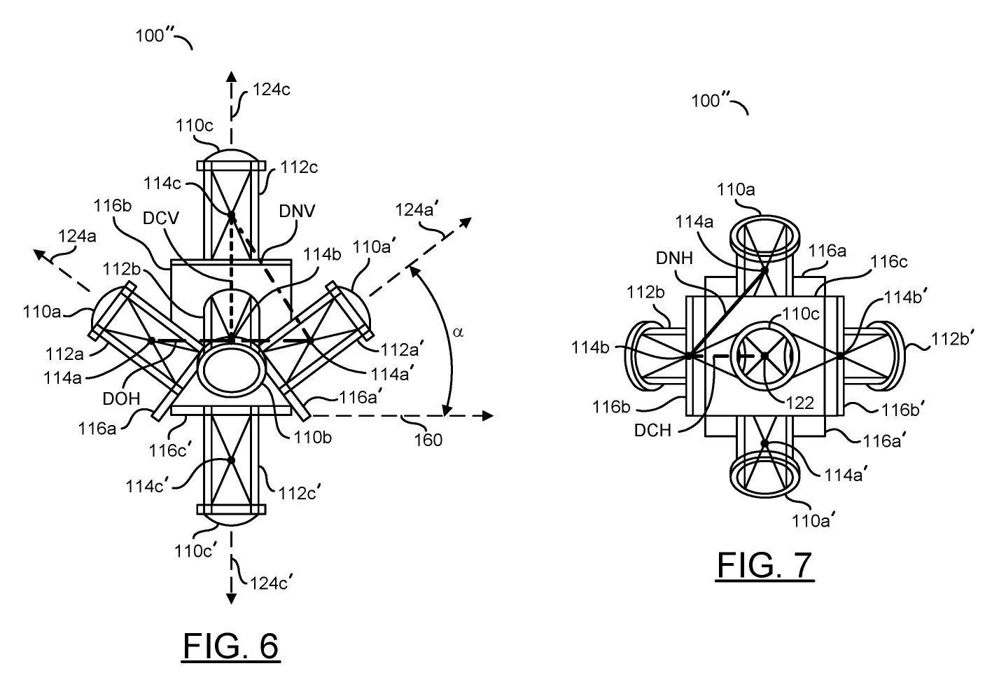

Referring to FIG. 6, a diagram illustrating a side view of an arrangement of the lenses 110 of the omnidirectional camera 100″ oriented to adjust (or configure) parallax effects is shown. A direction 160 is shown. The direction 160 may be a direction along a horizontal plane. The direction 160 may not correspond with the optical axes of the lenses 110. The direction 160 may correspond to the optical axis of the lens 110a′ of the embodiment 100′ shown in FIG. 3. The direction 160 is illustrated as a point of reference and the actual direction (e.g., along a horizontal axis) may be varied according to the orientation of the apparatus 100″.

The lenses 110a and 110a′ are shown tilted towards the direction 124c and away from the direction 124c′ (and the direction 160). For example, the lenses 110a and 110a′ may be tilted in an upwards direction. The lens 110b is shown tilted towards the direction 124c′ and away from the direction 124c. Similarly, the lens 110b′ may be tilted towards the direction 124c′. In the example shown, the four horizontally neighboring lenses (e.g., 110a, 110b, 110a′ and 110b′) are tilted in alternating directions around the periphery 120 (e.g., upwards, downwards, upwards, downwards). In the example with four lenses 110 around the periphery 120, the lenses 110 in each opposite lens pair are tilted in the same direction (e.g., the lenses 110a-110a′ may be tilted upwards, and the lenses 110b-110b′ may be tilted downwards). In embodiments with different numbers of lenses 110 arranged around the periphery 120, the lens pairs may be tilted in opposite directions (e.g., the lens 110a may be tilted upwards and the lens 110a′ may be tilted downwards).

The tilted lens 110a is shown having an optical axis 124a. The tilted lens 110a′ is shown having an optical axis 124a′. An angle α is shown between the direction 160 and the optical axis 124a′ of the lens 110a′. The angle α may be an amount of tilt (e.g., upward tilt) for the lenses 110. For example, the angle α may represent an amount of upward tilt for the lens 110a′ (and/or the lens barrel 112a′). In another example, the angle α may represent an amount of downward tilt for the lens 110b (and/or the lens barrel 112b). In some embodiments, the amount of tilt angle α may be the same value for one or more of the lenses 110. In some embodiments, the amount of tilt angle α may be different for each one of the lenses 110 (e.g., each of the horizontally oriented lenses 110 arranged around the periphery 120 may not be equidistant to the vertically oriented lenses 110c and/or 110c′). For example, when the amount of tilt angle α is different for the lenses 110, one or more of the lenses 110 arranged around the periphery 120 may be the nearest one of the horizontally oriented lenses to the vertically oriented lenses (e.g., the lenses 110c and/or 110c′). The nearest one of the horizontally oriented lenses 110 arranged around the periphery 120 to the vertically oriented lenses may be used to determine the distance DNV. The value of the angle α may be varied according to the design criteria of a particular implementation.

The centers of projection 114a, 114b, and 114a′ are shown aligned along a straight (e.g., horizontal) line (e.g., the line used to indicate the distance DOH) in the side view. The lens barrels 112 arranged around the periphery 120 may be oriented (e.g., entangled) such that the centers of projection 114a, 114b, 114a′ and 114b′ may be coplanar. In an example, the centers of projection 114a, 114b, 114a′ and 114b′ may be on the horizontal plane. When the centers of projection 114 for the lenses around the periphery 120 are coplanar, the parallax effects may be reduced (e.g., the centers of projection 114 may be closer together). In some embodiments, the lenses 110 around the periphery 120 may be tilted such that the centers of projection 114 are not coplanar.

Referring to FIG. 7, a diagram illustrating a top view of an arrangement of the lenses 110 of the omnidirectional camera 100″ oriented to adjust (or configure) parallax effects is shown. Tilting the lenses 110 (e.g., cameras) around the periphery 120 (e.g., horizontal plane) in alternating directions may leave some room to make the vertical lenses (e.g., the lenses 110c and 110c′) closer to each other. In the example shown, 4 of the lenses 110 are arranged around the periphery 120 (e.g., N=4). Additional lenses 110 (e.g., additional subsets of the lenses 110) may be added around the periphery 120 (e.g., N=6, N=8, N=10, etc.).

For embodiments having N tilted lenses 110 arranged around the periphery and the subset of lenses 110c-110c′ perpendicular to the periphery 120 the various distances shown may be calculated. The distance DNH may be calculated using an equation EQ 9:

$${D}_{NH} = \sqrt{\begin{matrix}{( \frac{B}{2} * ( \frac{1}{tan ( \frac{2 π}{N} )} + sin ( α ) ) + H cos ( α ) )}^{2} ( {( 1 - cos ( \frac{2 π}{N} ) )}^{2} + {sin ( \frac{2 π}{N} )}^{2} ) + \\ {( 2 ( - \frac{B}{2} cos ( α ) + ( H - T ) * sin ( α ) ) )}^{2}\end{matrix}}$$

The distance DCH may be calculated using an equation EQ 10:

$${D}_{CH} = \sqrt{\begin{matrix}{( \frac{B}{2} ( \frac{1}{tan ( \frac{2 π}{N} )} + sin ( α ) ) + H cos ( α ) )}^{2} + \\ {( - \frac{B}{2} cos ( α ) + ( H - T ) sin ( α ) )}^{2}\end{matrix}}$$

The distance DOH may be calculated using an equation EQ 11:

$${D}_{OH} = \sqrt{\begin{matrix}4 ⋆ {( \frac{B}{2} ( \frac{1}{tan ( \frac{2 π}{N} )} + sin ( α ) ) + H cos ( α ) )}^{2} + \\ 4 ( N \text{/} 2 mod 2 ) {( ( - \frac{B}{2} cos ( α ) + ( H - T ) ⋆ sin ( α ) ) )}^{2}\end{matrix}}$$

In the equation EQ 11, mod may represent the modulo operator (e.g., 1 mod 2=1, 2 mod 2=0, 3 mod 2=1, etc.). The distance DCV may be calculated using an equation EQ 12:

D_{CV}=H+V

A measurement V in the equation EQ 12 may represent a distance of the back of the bases 116 of the vertical lenses 116c and/or 116c′ (e.g., an elevation) from the rig center point 122. The distance DNV may be calculated using an equation EQ 13 (e.g., where ∥.∥ denotes an absolute value):

$${D}_{NV} = \sqrt{\begin{matrix}{( \frac{B}{2} ( \frac{1}{tan ( \frac{2 π}{N} )} + sin ( α ) ) + H cos ( α ) )}^{2} + \\ {( ( H + V ) - ‖ - \frac{B}{2} cos ( α ) + ( H - T ) sin ( α ) ‖ )}^{2}\end{matrix}}$$

In the embodiment of the omnidirectional camera 100″ having 4 of the lenses 110 around the periphery 120 (e.g., N=4), the various distance equations may be simplified. For N=4, the distance DNH may be calculated using an equation EQ 14:

$${D}_{NH} = \sqrt{2 {( \frac{B}{2} sin ( α ) + H cos ( α ) )}^{2} + 4 {( - \frac{B}{2} cos ( α ) + ( H - T ) sin ( α ) )}^{2}}$$

For N=4, the distance DCH may be calculated using an equation EQ 15:

$${D}_{CH} = \sqrt{{( B \text{/} 2 )}^{2} + {( H cos ( α ) )}^{2} + {( ( H - T ) sin ( α ) )}^{2} + BT sin ( α ) cos ( α )}$$

For N=4, the distance DOH may be calculated using an equation EQ 16:

D_{OH}=2H cos(α)+B sin(α)

For N=4, the distance DCV may be calculated using an equation EQ 17:

D_{CV}=H+V

For N=4, the distance DNV may be calculated using an equation EQ 18:

$${D}_{NV} = \sqrt{\begin{matrix}{( H cos ( α ) + \frac{B}{2} sin ( α ) )}^{2} + \\ ( {( H + V - ‖ ( H - T ) sin ( α ) - \frac{B}{2} cos ( α ) ‖ )}^{2}\end{matrix}}$$

In an example, values for the various equations may be N=4, H=20 mm, B=25 mm, and α=45°. The distance DNH=33 mm (e.g., a smaller value than the non-tilted example embodiment 100′). The distance DNH may be the distance having the greatest impact on parallax effects (e.g., minimizing the distance DNH may contribute the most to reducing parallax effects). The distance DCH=23 mm (e.g., a smaller value than the non-tilted example embodiment 100′). The distance DOH=46 mm (e.g., a smaller value than the non-tilted example embodiment 100′).

In some embodiments, the lenses 110 around the periphery 120 may be arranged to eliminate vertical parallax. The vertical parallax may be eliminated when the optical centers (e.g., 114a, 114b, 114a′ and 114b′) of the lenses 110 around the periphery 120 are coplanar. The optical centers 114a, 114b, 114a′ and 114b′ may be coplanar when the condition shown in an equation EQ 19 is met:

(H−T)sin(α)−B/2·cos(α)=0

Equivalently, the optical centers 114a, 114b, 114a′ and 114b′ may be coplanar when the condition shown in an equation EQ 20 is met:

tan(α)=B/(2*(H−T))

The lenses 110 that are not arranged around the periphery 120 (e.g., the vertical subset of lenses 110c-110c′) may be arranged in various configurations. The configuration for the vertical subset of lenses 110c-110c′ may be selected based on physical space available and/or the pre-determined purpose. In an example, the distance V may be increased or decreased (e.g., the lenses 110c-110c′ may be closer together or farther apart).

In some embodiments, the distance V for the lenses 110c-110c′ may be selected such that the distance DCV is equal to the distance DCH (e.g., the distance from the optical centers 114 for each of the lenses 110 to the center point 122 would be equal). In the example shown, the 6 optical centers 114 of the lenses 110 would be placed on a sphere having a radius DCH.

In some embodiments, the distance V for the lenses 110c-110c′ may be selected such that the distance DNV of the optical centers 114c-114c′ to a closest optical center 114 of the lenses 110 arranged around the periphery 120 is equal to the distance DNH. When the distance DNV is equal to the distance DNH, the parallax between the closest neighboring lenses 110 may be the same, regardless of a position of the lenses 110 (e.g., on the vertical axis, or close to the horizontal plane).

In some embodiments, the distance V for the lenses 110c-110c′ may be selected to reduce (e.g., minimize) the distance DNV of the optical centers 114c-114c′ to the optical centers 114 of a closest one of the horizontal lenses 110 arranged around the periphery 120. The distance DNV may be minimum when the optical center 114c (or 114c′) of the vertical axis lens 110c (or 110c′) is aligned with the optical center 114 of the two closest neighboring lenses 110 arranged around the periphery 120 (e.g., at the same elevation). The distance DNV may be a minimum when an equation EQ 21 is satisfied (e.g., where ∥.∥ denotes an absolute value):

V+H=∥(H−T)sin(α)−B/2·cos(α)∥

In some embodiments, the distance V for the lenses 110c-110c′ may be selected to be a smallest possible value. The smallest possible value for the distance V may keep the vertical lenses 110c-110c′ as close as possible to the center of the lens rig 122. A reduction of the distance V may be limited by the physical dimensions of the bases 116 of the lenses 110. The bases 116c-116c′ of the vertical lenses 110c-110c′ may be in contact with the bases (e.g., 116a-116a′ and 116b-116b′) of the horizontal lenses 110 arranged around the periphery 120. An equation EQ 22 may be satisfied when the bases 116 are in contact:

V=T·sin(α)+B(2·tan(α))

Depending on the physical occupancy of the lenses 110, the lens barrels 112, the bases 116 (e.g., frames) and/or the angle α, not all arrangements may be achievable. In some embodiments, satisfying the equation EQ 21 may be preferable. However, satisfying the equation EQ 21 may not be possible when the optical centers 114 of the lenses 110 arranged around the periphery 120 are coplanar. When the optical centers 114 of the lenses 110 arranged around the periphery 120 are coplanar, an equation EQ 23 may be satisfied:

(H−T)sin(α)−B/2·cos(α)=0

In order to satisfy the equation EQ 23, V may be opposite to H.

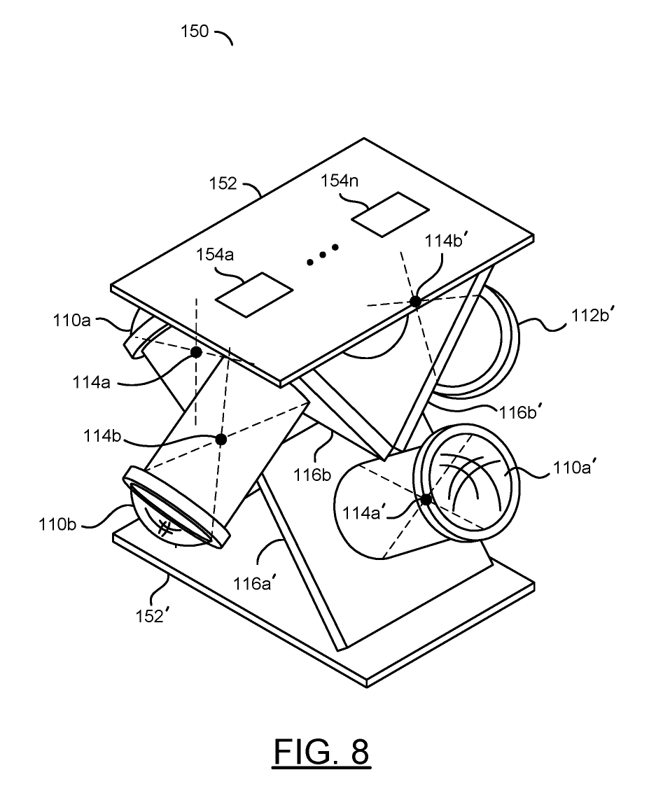

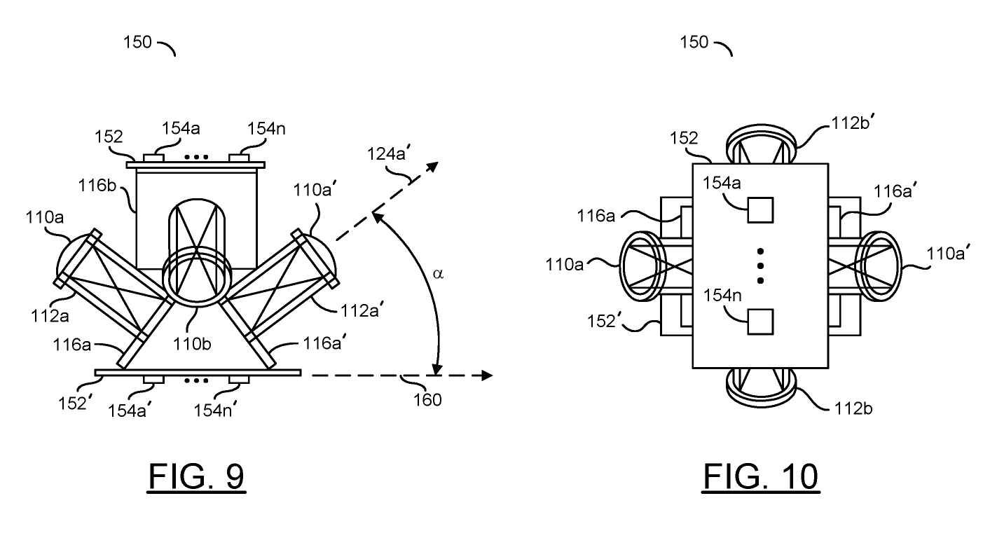

Referring to FIG. 8, a diagram illustrating an isometric view of circuit board placement for an example embodiment of an omnidirectional camera 150 is shown. Printed circuit boards (PCB) 152-152′ are shown attached to the omnidirectional camera 150. PCBs 152-152′ may be used to support and/or interconnect electronics of the sensors and/or camera video processors. The PCB 152 may comprise blocks (or circuits) 154a-154n. The circuits 154a-154n may comprise electronics, circuit packages (chips) and/or processors. The types of the circuits 154a-154n may be varied according to the design criteria of a particular implementation. Referring to FIG. 9, a diagram illustrating a side view of circuit board placement for an example embodiment of the omnidirectional camera 150 is shown. The circuit board 152 is shown on a top of the omnidirectional camera 150. The circuit board 152′ is shown on the bottom of the omnidirectional camera 150. The circuit board 152′ may comprise the circuits 154a′-154n′. In some embodiments, the circuitry 154a′-154n′ for the circuit board 152′ may be similar to the circuitry 154a-154n for the circuit board 152. In an example, the circuitry 154a-154n may include a video processor used by the lenses 110a-110a′ and the circuitry 154a′-154n′ may include a video processor used by the lenses 110b-110b′. In some embodiments, the circuitry 154a′-154n′ for the circuit board 152′ may be different to the circuitry 154a-154n for the circuit board 152. In an example, the circuitry 154a-154n may comprise two video processors used by the lenses 110a-110a′ and 110b-110b′ and the circuitry 154a′-154n′ may comprise components used to provide power to the sensors.

Referring to FIG. 10, a diagram illustrating a top view of circuit board placement for an example embodiment of an omnidirectional camera 150 is shown. The omnidirectional camera 150 is shown having 4 lenses (e.g., 110a-110a′ and 110b-110b′). In an example, one subset of the lenses 110 may comprise 2 lenses (e.g., 110a-110a′), one subset of the lenses 110 may comprise 1 lens (e.g., the lens 110b) and one subset of the lenses 110 may comprise 1 lens (e.g., the lens 110b′). In an example, each subset of the lenses 110 may be arranged around the periphery 120. The tilt of each subset of the lenses 110 may be different. The lenses 110 comprising each subset of the lenses 110 may be varied according to the design criteria of a particular implementation.

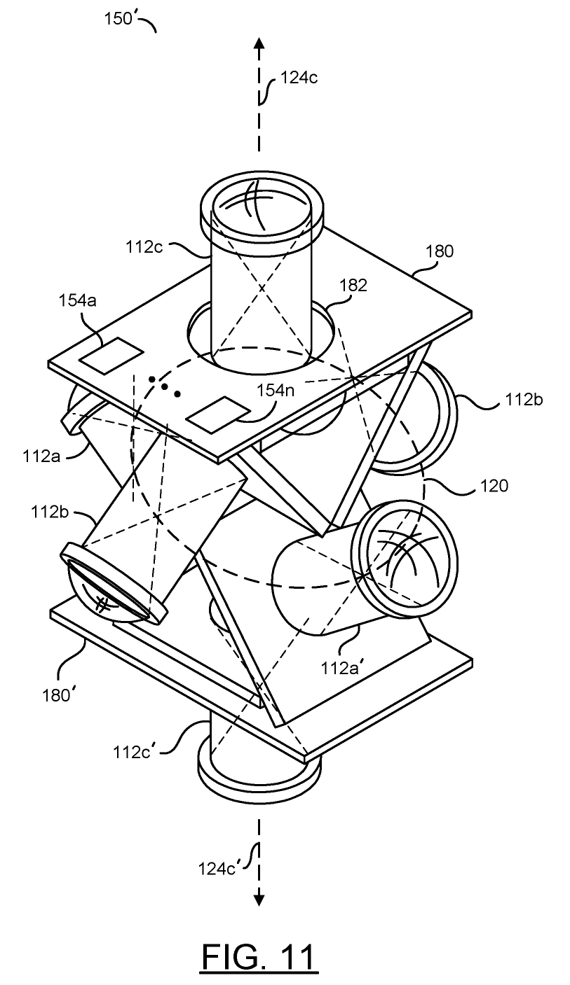

Referring to FIG. 11, a diagram illustrating an isometric view of the lenses 110 passing through a circuit board hole for an example embodiment of an omnidirectional camera 150′ is shown. The omnidirectional camera 150′ is shown having the lens barrels 112 arranged around the periphery 120 tilted in alternating directions. The omnidirectional camera 150′ may comprise a circuit board 180 and a circuit board 180′. The circuit board 180 may comprise the circuitry 154a-154n. Similarly, the circuit board 180′ may comprise the circuitry 154a′-154n′.

The circuit board 180 is shown comprising a hole 182. The solid circuit board 152 shown in FIGS. 8-10 may physically block a placement of the vertically oriented subset of lenses 110c-110c′. The hole 182 implemented on the circuit board 180 may allow the sensors, lenses 110c-110c′ and/or the lens barrels 112c-112c′ to fit through the circuit boards 180 (or the circuit board 180′). For example, using the hole 182, the optical axis 124c of the lens 110c may not be obstructed. The circuit board 180′ may have a similar implementation with the hole 182 (not shown).

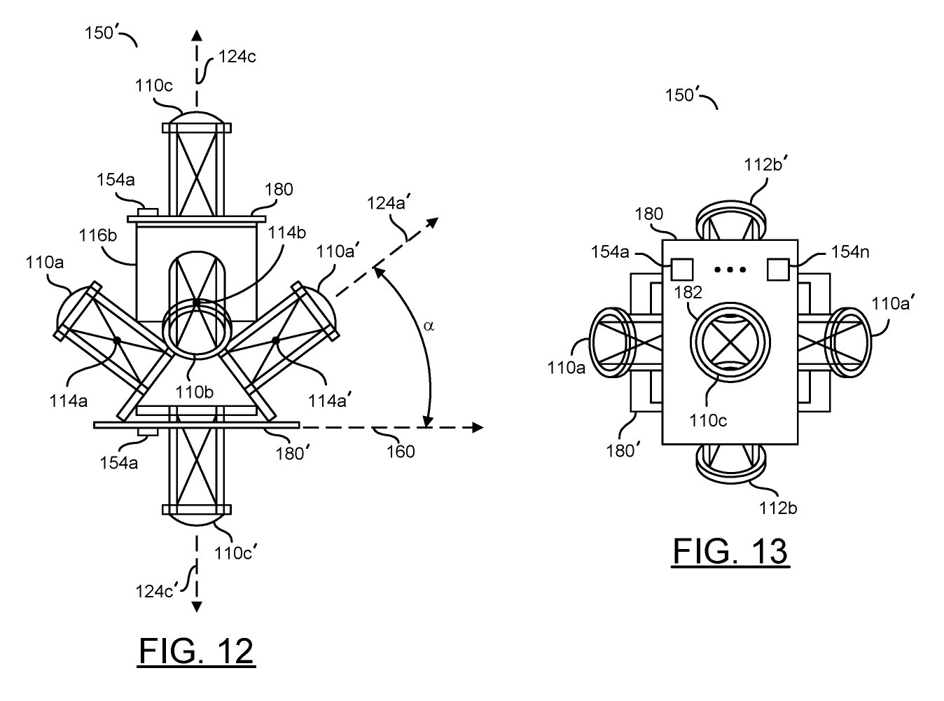

Referring to FIG. 12, a diagram illustrating a side view of one or more of the lenses 110 passing through a circuit board hole for the example embodiment of the omnidirectional camera 150′ is shown. The circuit board 180 is shown on a top side of the omnidirectional camera 150′. The circuit board 180 is shown on a bottom side of the omnidirectional camera 150′. The circuit board 180 and the circuit board 180′ are shown comprising circuitry 154a.

The lens barrel 112c′ is shown passing through the circuit board 180′. In an example, the circuit board 180′ may comprise the hole 182. The hole 182 may allow an unobstructed view of the optical axis 124c′ by the lens 110c′.

The lenses 110 are shown around the periphery 120. In some embodiments, the centers of projection 114a-114a′ and 114b-114b′ may not be coplanar. In the example shown, the center of projection 114b is shown located higher than the centers of projection 114a-114a′.

Referring to FIG. 13, a diagram illustrating a top view of one or more of the lenses 110 passing through a circuit board hole for the example embodiment of the omnidirectional camera 150′ is shown. The circuit board 180 is shown implemented having a rectangular shape. The circuit board 180 is shown longer in a direction towards the lens barrels 112b-112b′. Since the lens barrels 112b-112b′ are tilted downwards, and the lens barrels 112a-112a′ are tilted upwards, the upper circuit board 180 may be longer in a direction towards the lens barrels 112b-112b′ (e.g., the lens barrels 112a-112a′ may physically prevent a placement of the circuit board 180). Similarly, the circuit board 180′ is shown longer in a direction towards the lens barrels 112a-112a′. Since the lens barrels 112a-112a′ are tilted downwards, the lower circuit board 180′ may be longer in a direction towards the lens barrels 112a-112a′ (e.g., the lens barrels 112b-112b′ may physically prevent a placement of the circuit board 180′). For example, the circuit board 180 and the circuit board 180′ may extend above the lenses 110 arranged around the periphery 120 that extend in a direction opposite to the location of the respective circuit board 180 and the circuit board 180′.

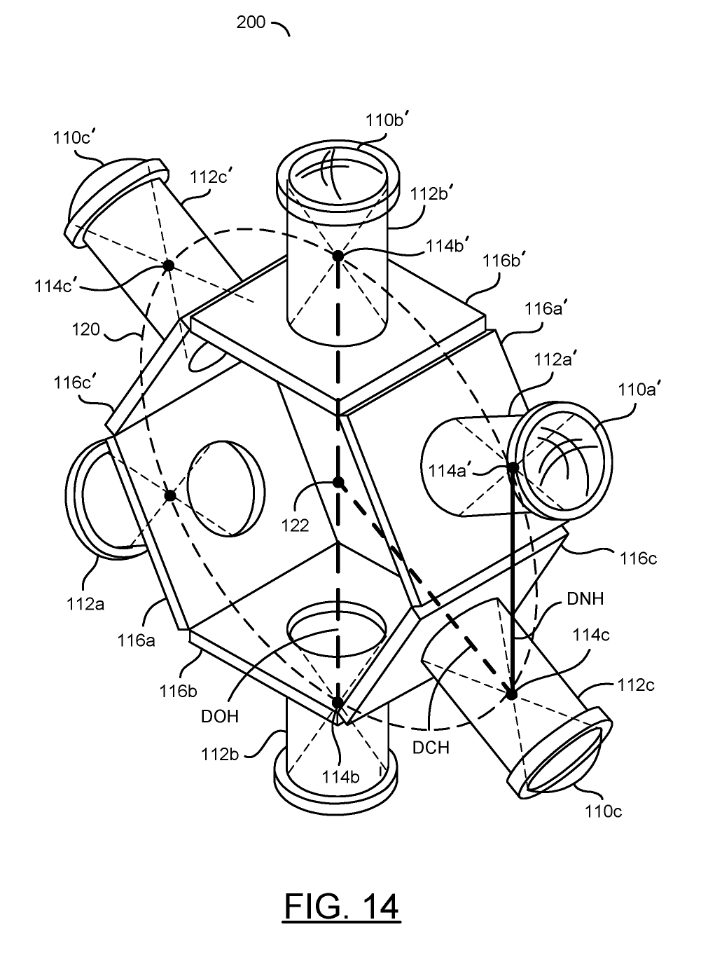

Referring to FIG. 14, a diagram illustrating an isometric view of an example embodiment with all the lenses 110 around the periphery 120 of an omnidirectional camera 200 is shown. The subsets of lenses 110a-110a′, 110b-110b′ and/or 110c-110c′ are shown. Each of the lenses 110 may be arranged around the periphery 120. The bases 116 of the lenses 110 that are adjacent to each other are shown touching. The bases 116 may be arranged to form a radius around the periphery 120. Arranging the lenses 110 around the periphery 120 may enable the omnidirectional camera 200 to capture images in each direction.

The distance DOH is shown between the center of projection 114b and the center of projection 114b′. The distance DCH is shown between the center of projection 114c and the center point of the lens rig 122. The distance DNH is shown between the center of projection 114c and the center of projection 114a′.

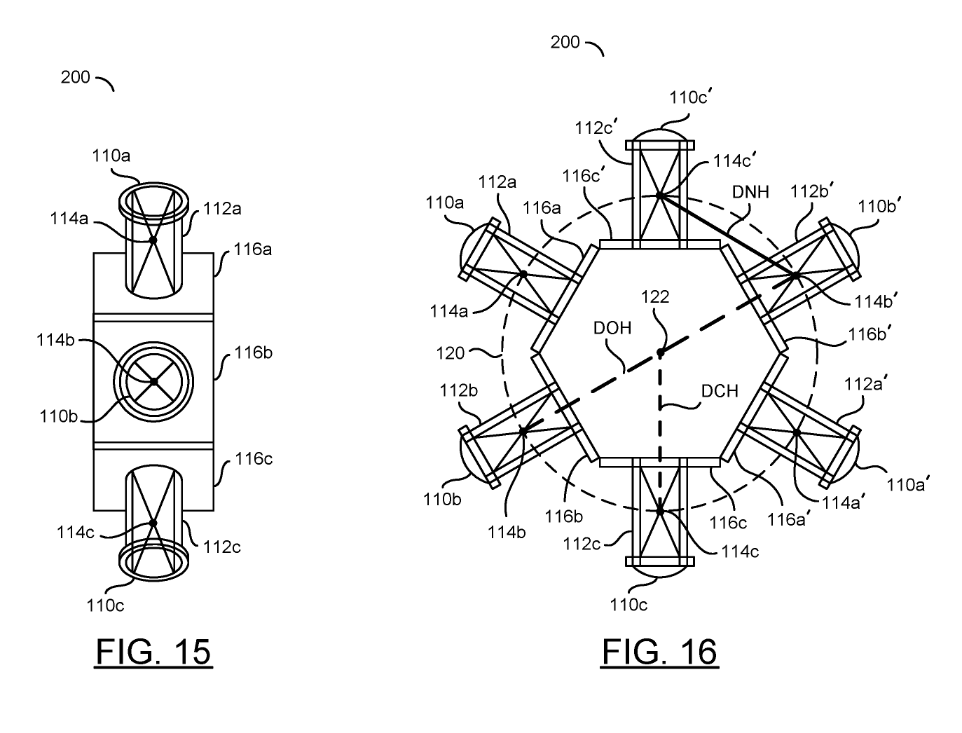

Referring to FIG. 15, a diagram illustrating a side view of an example embodiment with all the lenses 110 around the periphery 120 of the omnidirectional camera 200 is shown. The omnidirectional camera 200 may comprise 6 of the lenses 110. The lenses 110 may be arranged as opposite lens pairs. The subset of the lenses 110a-110a′, the subset of the lenses 110b-110b′ and the subset of the lenses 110c-110c′ may each be an opposite lens pair.

One of the lenses 110a of the subset of the lenses 110a-110a′ is shown neighboring (e.g., horizontally neighboring) one of the lenses 110b of the subset of the lenses 110b-110b′. One of the lenses 110b of the subset of the lenses 110b-110b′ is shown neighboring one of the lenses 110c of the subset of the lenses 110c-110c′. Similarly, one of the lenses 110a of the subset of the lenses 110a-110a′ may be neighboring one of the lenses 110c′ of the subset of the lenses 110c-110c′. Similarly, one of the lenses 110c of the subset of the lenses 110c-110c′ may be neighboring one of the lenses 110a′ of the subset of the lenses 110a-110a′. Generally, one lens from each of the subsets of the lenses 110 may be neighboring one lens from one subset and another lens of another subset.

Referring to FIG. 16, a diagram illustrating a top view of an example embodiment with all the lenses 110 around the periphery 120 of the omnidirectional camera 200 is shown. For the arrangement of the lenses 110 of the omnidirectional camera 200, the distance DNH may be determined by an equation EQ 24:

D_{NH}=B\sqrt{3}/2+H

The distance DCH may be determined by an equation EQ 25:

D_{CH}=B\sqrt{3}/2+H

For the arrangement of the lenses 110 of the omnidirectional camera 200, the distance DNH may be equal to the distance DCH. The distance DOH may be determined by an equation EQ 26:

D_{OH}=2*D_{CH}=B\sqrt{3}+2H

In an example with 6 of the lenses 110 (e.g., N=6), and values of H=20 mm, B=25 mm, and T=5 mm, the distance DNH=42 mm, the distance DCH=42 mm and the distance DOH=83 mm.

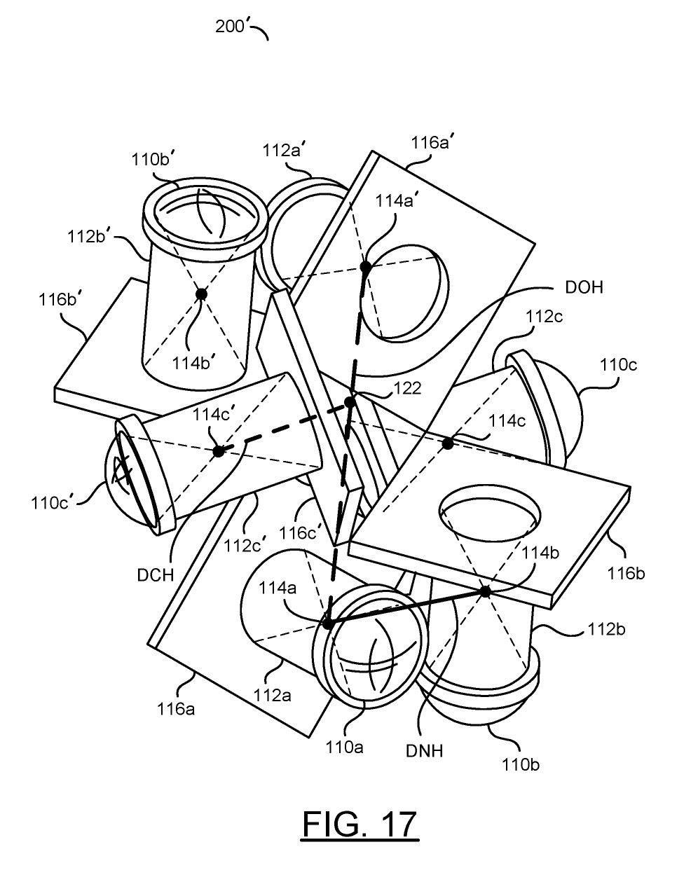

Referring to FIG. 17, a diagram illustrating an isometric view of an example embodiment with all the lenses 110 around the periphery 120 of an omnidirectional camera 200′ and oriented to adjust (or configure) parallax effects is shown. The lenses 110a-110a′, 110b-110b′ and/or 110c-110c′ are shown arranged around the periphery 120. Each of the lenses 110 may be tilted in alternating directions around the periphery 120. The bases 116 of the lenses 110 and the lens barrels 112 may be entangled to select the parallax effects created when generating the spherical video for a pre-determined purpose. Tilting the horizontally neighboring lenses 110 in alternating directions around the periphery 120 may enable the omnidirectional camera 200′ to capture the environment surrounding the omnidirectional camera 200′ in all directions. In an example, tilting the lenses 110 upwards may enable the omnidirectional camera 200′ to capture areas above the omnidirectional camera 200′. The lenses 110 that are adjacent to each other are shown tilted in opposite directions (e.g., directed upwards or downwards).

The distance DOH is shown between the center of projection 114a and the center of projection 114a′. The distance DCH is shown between the center of projection 114c′ and the center point of the lens rig 122. The distance DNH is shown between the center of projection 114a and the center of projection 114b.

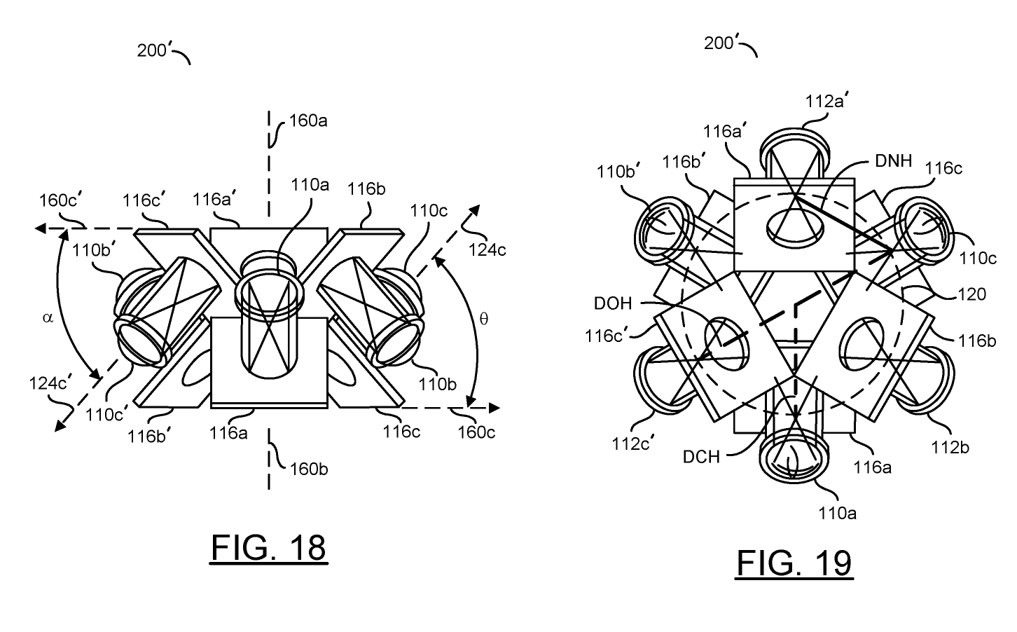

Referring to FIG. 18, a diagram illustrating a side view of an example embodiment with all the lenses 110 around the periphery 120 of the omnidirectional camera 200′ and oriented to adjust (or configure) parallax effects is shown. The lenses 110 are shown tilted in alternating directions around the periphery 120. A direction 160a is shown. The direction 160a may be a direction above the omnidirectional camera 200′. A direction 160b is shown. The direction 160b may be a direction below the omnidirectional camera 200′. The lenses 110 around the periphery 120 may be directed towards the direction 160a or the direction 160b. In the example shown, the lens 110a may be directed towards the direction 160a (e.g., upwards), the lens 110b may be directed towards the direction 160b (e.g., downwards), the lens 110c may be directed towards the direction 160a (e.g., upwards), the lens 110a′ may be directed towards the direction 160b (e.g., downwards), the lens 110b′ may be directed towards the direction 160a (e.g., upwards) and the lens 110c′ may be directed towards the direction 160b (e.g., downwards).

A direction 160c is shown. The direction 160c may be a reference direction. The reference direction 160c may be a direction along a horizontal plane. A direction 160c′ is shown. The direction 160c′ may be a reference direction. The reference direction 160c′ may be a direction along a horizontal plane. A direction 124c is shown. The direction 124c may be a direction of the optical axis of the lens 110c. The optical axis 124c of the lens 110c may be directed towards the direction 160a (e.g., upwards). A direction 124c′ is shown. The direction 124c′ may be a direction of the optical axis of the lens 110c′. The optical axis 124c′ of the lens 110c′ may be directed towards the direction 160b (e.g., downwards).

The angle α is shown between the direction 160c′ and the optical axis 124c′ of the lens 110c′. The angle α may be an amount of tilt (e.g., downward tilt) for the lenses 110. For example, the angle α may represent an amount of downward tilt (e.g., towards the direction 160b) for the lenses 110a′, 110c′ and/or 110b. In some embodiments, the value of the angle α may be different for each of the lenses 110 that are tilted downwards.

An angle θ is shown between the direction 160c and the optical axis 124c of the lens 110c. The angle θ may be an amount of tilt (e.g., upward tilt) for the lenses 110. For example, the angle θ may represent an amount of upward tilt (e.g., towards the direction 160a) for the lenses 110a, 110c and/or 110b′. In some embodiments, the value of the angle θ may be different for each of the lenses 110 that are tilted upwards.

The lenses 110 may be oriented to adjust (or configure) parallax effects. The parallax effects may be based on the locations of the centers of projection 114 of the lenses 110. The type of parallax effects resulting from the locations of the centers of projection 114 may be varied by adjusting the height of the lens barrels 112, the thickness T of the bases 116, the width B of the bases 116 and/or the orientation of the lenses 110 (e.g., based on the angles α and/or the angles θ of each of the lenses 110).

Referring to FIG. 19, a diagram illustrating a top view of an example embodiment with all the lenses 110 around the periphery 120 of an omnidirectional camera 200′ and oriented to adjust (or configure) parallax effects is shown. The lenses 110 may be tilted in alternating directions around the periphery 120. In the example shown with 6 of the lenses 110 (e.g., N=6), the horizontally opposite lens pairs (e.g., the opposite lens pair 110a-110a′, the opposite lens pair 110b-110b′ and the opposite lens pair 110c-110c′) may each be directed in opposite directions. In the example shown, for the opposite lens pair 110a-110a′, the lens 110a may be tilted upwards and the lens 110a′ may be tilted downwards. In the example shown, for the opposite lens pair 110b-110b′, the lens 110b may be tilted downwards and the lens 110b′ may be tilted upwards. In the example shown, for the opposite lens pair 110c-110c′, the lens 110c may be tilted upwards and the lens 110c′ may be tilted downwards. A particular one of the lenses 110 in each of the lens pairs that is tilted in a particular direction may be varied according to the design criteria of a particular implementation.

In the tilted configuration of the omnidirectional camera 200′, the distance DNH may be determined using an equation EQ 27:

$${D}_{NH} = \sqrt{\begin{matrix}{( \frac{B}{2} ( sin ( α ) + \frac{1}{\sqrt{3}} ) + H cos ( α ) )}^{2} + \\ {( B cos ( α ) - 2 ( H - T ) sin ( α ) )}^{2}\end{matrix}}$$

In the tilted configuration of the omnidirectional camera 200′, the distance DCH may be determined using an equation EQ 28:

$${D}_{CH} = \sqrt{\begin{matrix}{( \frac{B}{2} ( sin ( α ) + \frac{1}{\sqrt{3}} ) + H cos ( α ) )}^{2} + \\ {( \frac{B}{2} cos ( α ) - ( H - T ) sin ( a ) )}^{2}\end{matrix}}$$

In the tilted configuration of the omnidirectional camera 200′, the distance DOH may be determined using an equation EQ 29:

$${D}_{OH} = \sqrt{\begin{matrix}{( B ( sin ( α ) + \frac{1}{\sqrt{3}} ) + 2 H cos ( α ) )}^{2} + \\ {( B cos ( α ) - 2 ( H - T ) sin ( α ) )}^{2}\end{matrix}}$$

Using the equations EQ 27, EQ 28 and EQ 29 with example numerical values of N=6, H=20 mm, B=25 mm, and α=45°, the distance DNH=30 mm (e.g., a smaller distance than the distance DNH in the non-tilted example shown in FIGS. 14-16), DCH=30 mm (e.g., a smaller distance than the distance DCH in the non-tilted example shown in FIGS. 14-16), and DOH=60 mm (e.g., a smaller distance than the distance DOH in the non-tilted example shown in FIGS. 14-16). In some embodiments, the lenses 110 may be arranged such that the centers of projection 114 may be coplanar. The centers of projection 114 may be coplanar using the same condition as in an embodiment having 4 of the lenses 110. The centers of projection 114 may be coplanar when the condition shown in an equation EQ 30 is met:

tan(α)=B/(2*(H−T))

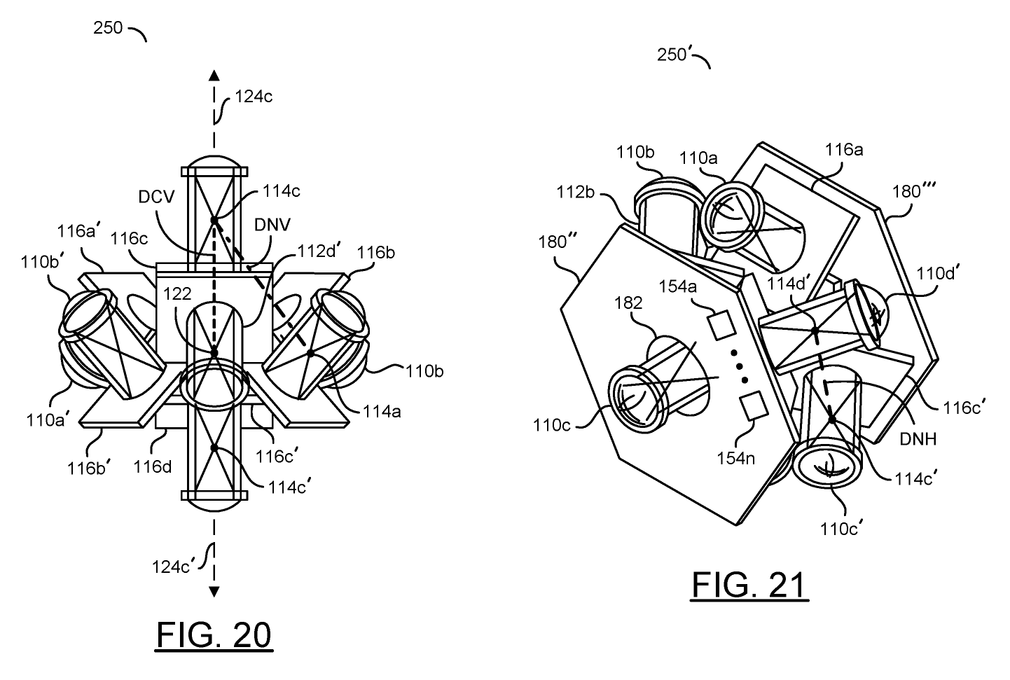

Referring to FIG. 20, a diagram illustrating an example embodiment 250 having six of the lenses 110 around the periphery 120 and two vertically oriented lenses is shown. The opposite lens pair 110c-110c′ may be one of the subset of the lenses 110. The opposite lens pair 110c-110c′ may be the vertically oriented lenses. The opposite lens pair 110c-110c′ may point in opposite directions (e.g., the lens 110c may have the optical axis 124c and the lens 110c′ may have the optical axis 124c′). In some embodiments, the opposite lens pair 110c-110c′ may point in nearly opposite directions (e.g., the lenses 110c-110c′ may be tilted but still vertically oriented and/or generally perpendicular to the periphery 120). The distance DCV is shown between the center of projection 114c and the center point of the lens rig 122.

The omnidirectional camera embodiment 250 may have six of the lenses 110 around the periphery 120 (e.g., one subset of the lenses 110a-110a′, one subset of the lenses 110b-110b′ and one subset of the lenses 110d-110d′). The distance DNV is shown between the center of projection 114c and the center of projection 114a. The lenses 110 arranged around the periphery 120 may be alternately tilted towards opposite directions. In an example, one of the lenses 110 may be tilted towards a different direction than both of the horizontally neighboring lenses.

In the embodiment shown, the lens 110d′ is shown tilted towards the direction 124c′, in a counterclockwise direction around the periphery 120 the next lens 110a is shown tilted towards the direction 124c, in a counterclockwise direction around the periphery 120 the next lens 110b is shown tilted towards the direction 124c′, in a counterclockwise direction around the periphery 120 the next lens 110d (not visible in the perspective shown in FIG. 20) is tilted towards the direction 124c, in a counterclockwise direction around the periphery 120 the next lens 110a′ is shown tilted towards the direction 124c′, in a counterclockwise direction around the periphery 120 the next lens 110b′ is shown tilted towards the direction 124c, in a counterclockwise direction around the periphery 120 the next lens may be the lens 120d′. The amount of tilt for each of the lenses is shown approximately equal. In some embodiments, each of the lenses 110 arranged around the periphery 120 may have a different amount of tilt.

Similar to the omnidirectional camera embodiment 200′, the distances DNH, DCH and DOH for the omnidirectional camera embodiment 250 may be calculated using the equations EQ 27, EQ 28 and EQ 29. The distance DCV for the vertical lenses 110c-110c′ may be calculated using an equation EQ 31:

D_{CV}=H+V

The distance DNV may be calculated using an equation EQ 32:

$${D}_{NV} = \sqrt{\begin{matrix}{( \frac{B}{2} ( sin ( α ) + \frac{1}{\sqrt{3}} ) + H cos ( α ) )}^{2} + \\ {( ‖ \frac{B}{2} cos ( α ) - ( H - T ) sin ( α ) ‖ - ( H + V ) )}^{2}\end{matrix}}$$

The placement of the opposite lens pair 110c-110c′ may be selected according to the pre-determined purpose. In some embodiments, the lenses 110c-110c′ may be directed towards a particular direction of interest. In one example, the lenses 110c-110c′ may be arranged such that the distance DCV may be equivalent (or nearly equal) to the distance DCH (e.g., the 8 optical centers 114 of the lenses 110 may be arranged as a sphere having a radius equal to the distance DCH). In another example, the lenses 110c-110c′ may be arranged such that the distance DNV may be equal (or nearly equal) to the distance DNH. When the distance DNV is equal (or nearly equal) to the distance DNH the parallax between the closest neighboring lenses 110 may be the same regardless of a position of the lens 110 (e.g., on the vertical axis, or close to the horizontal plane).

In yet another example, the lenses 110c-110c′ may be arranged such that the distance DNV between the lenses 110c-110c′ and a closest one of the lenses 110 arranged around the periphery 120 is reduced (e.g., at a minimum value). The distance DNV may be at a minimum value when the optical center 114 of a vertical axis lens 110 is at the same vertical elevation as the optical center 114 of one of the closest neighboring lenses 110. A condition for when the distance DNV is at a minimum value may be when an equation EQ 33 is satisfied (e.g., where denotes the absolute value):

V+H=∥(H−T)sin(α)−B/2·cos(α)∥

In still another example, the lenses 110c-110c′ may be arranged such that the distance V between the base 116c and the base 116c′ is a smallest possible value (e.g., to keep the vertical lenses 110c-110c′ as close as possible to the center of the lens rig 122. The bases 116c-116c′ may be in contact with the bases (e.g., 116a-116a′, 116b-116b′ and/or 116d-116d′) of the lenses (e.g., 110a-110a′, 110b-110b′ and/or 110d-110d′) arranged around the periphery 120. For example, the distance DOH may not be large enough for the bases 116c-116c′ to entirely fit between the lenses 110 arranged around the periphery 120.

Depending on a physical occupancy of the lenses barrels 112, the bases 116 and/or the angles (e.g., a and/or 0) the lenses 110 are tilted, not all possibilities for physical arrangement of the lenses 110 may be physically realized. In an example, the arrangement where the distance DNV between the lenses 110c-110c′ and a closest one of the lenses 110 arranged around the periphery 120 is reduced (e.g., at a minimum value) may be preferred but may not be achieved when the optical centers 114 of the lenses 110 arranged around the periphery 120 are coplanar on the horizontal plane. The optical centers 114 of the lenses 110 arranged around the periphery 120 may be coplanar on the horizontal plane when an equation EQ 34 is satisfied:

(H−T)sin(α)−B/2·cos(α)=0

The equation EQ 34 may be satisfied when the distance V is opposite to the distance H.

Referring to FIG. 21, a diagram illustrating an example embodiment 250′ having six of the lenses 110 around the periphery 120 and two vertically oriented lenses passing through a hole of a circuit board is shown. The omnidirectional camera embodiment 250′ may have a similar arrangement of the lenses 110 as the omnidirectional camera embodiment 250. The circuit board 180″ is shown located at one end of the omnidirectional camera embodiment 250′. The circuit board 180′″ is shown at another end of the omnidirectional camera embodiment 250′.

The circuit board 180″ is shown having the hole 182. The hole 182 may allow the lens 110c to fit through the circuit board 180″. Similarly, the circuit board 180′″ may have the hole 182 to allow the lens 110c′ to fit through the circuit board 180′″. The hole 182 may enable the lenses that are not arranged around the periphery 120 (e.g., the opposite lens pair 110c-110c′) to capture the environment surrounding the omnidirectional camera 250′ without being obstructed by the circuit board 180″ (or the circuit board 180′″).

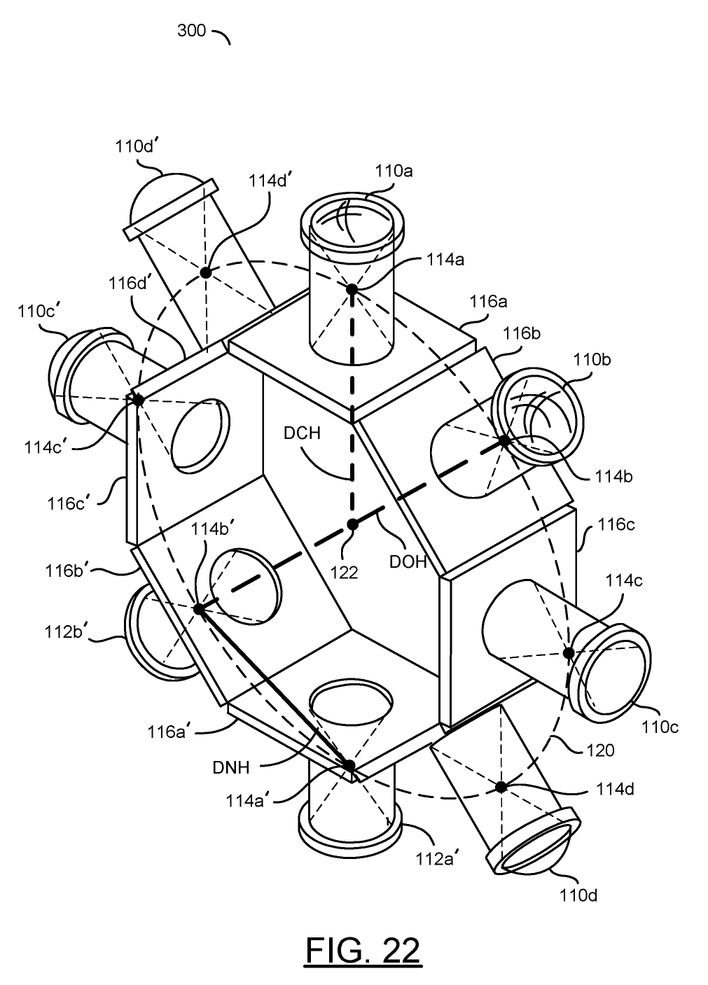

Referring to FIG. 22, a diagram illustrating an example embodiment with eight of the lenses 110 arranged around the periphery 120 of an omnidirectional camera 300 is shown. Each of the lenses 110 may be arranged around the periphery 120. The subset of the lenses 110a-110a′, 110b-110b′, 110c-110c′ and/or 110d-110d′ are shown. The bases 116 of the lenses 110 that are adjacent to each other are shown touching. The bases 116 may be arranged to form a radius around the periphery 120. Arranging the lenses 110 around the periphery 120 may enable the omnidirectional camera 300 to capture images in each direction.

The omnidirectional camera 300 may comprise 8 of the lenses 110. The lenses 110 may be arranged as opposite lens pairs. The subset of the lenses 110a-110a′, the subset of the lenses 110b-110b′, the subset of the lenses 110c-110c′ and the subset of the lenses 110d-110d′ may each be an opposite lens pair.

One of the lenses 110a of the subset of the lenses 110a-110a′ is shown neighboring (e.g., horizontally neighboring) one of the lenses 110b of the subset of the lenses 110b-110b′. One of the lenses 110b of the subset of the lenses 110b-110b′ is shown neighboring one of the lenses 110c of the subset of the lenses 110c-110c′. One of the lenses 110c of the subset of the lenses 110c-110c′ is shown neighboring one of the lenses 110d of the subset of the lenses 110d-110d′. Similarly, one of the lenses 110a of the subset of the lenses 110a-110a′ may be neighboring one of the lenses 110d′ of the subset of the lenses 110d-110d′. Similarly, one of the lenses 110d of the subset of the lenses 110d-110d′ may be neighboring one of the lenses 110a′ of the subset of the lenses 110a-110a′. Generally, one lens from each of the subsets of the lenses 110 may be neighboring one lens from one subset and another lens of another subset of the lenses 110.

The distance DOH is shown between the center of projection 114b and the center of projection 114b′. The distance DCH is shown between the center of projection 114a and the center point of the lens rig 122. The distance DNH is shown between the center of projection 114b′ and the center of projection 114a′.

For the arrangement of the lenses 110 of the omnidirectional camera 300, the distance DNH may be determined by an equation EQ 35:

$${D}_{NH} = ( 1 + \sqrt{2} ) ( \frac{\sqrt{2} + 1}{2} B + H )$$

The distance DCH may be determined by an equation EQ 36:

$${D}_{CH} = \frac{\sqrt{2} + 1}{2} B + H$$

For the arrangement of the lenses 110 of the omnidirectional camera 300, the distance DNH may not be equal to the distance DCH. The distance DOH may be determined by an equation EQ 37:

D_{OH}=(\sqrt{2}+1)B+2H

In an example with 8 of the lenses 110 (e.g., N=8), and values of H=20 mm, B=25 mm, and T=5 mm, the distance DNH=38 mm, the distance DCH=50 mm and the distance DOH=100 mm.

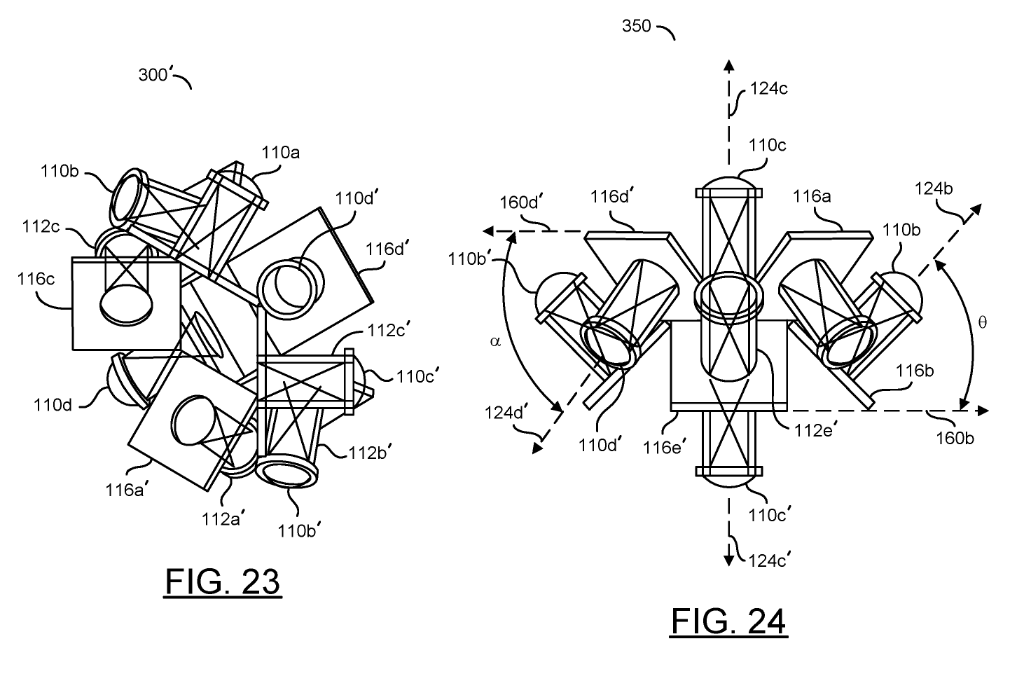

Referring to FIG. 23, a diagram illustrating an example embodiment with eight of the lenses 110 arranged around the periphery 120 of an omnidirectional camera 300′ oriented to adjust (or configure) parallax effects is shown. The lenses 110a-110a′, 110b-110b′, 110c-110c′ and/or 110d-110d′ are shown arranged around the periphery 120. Each of the lenses 110 may be tilted in alternating directions around the periphery 120. The bases 116 of the lenses 110 and the lens barrels 112 may be entangled to select the parallax effects created when generating the spherical video for a pre-determined purpose. Tilting the lenses 110 in alternating directions around the periphery may enable the omnidirectional camera 300′ to capture the environment surrounding the omnidirectional camera 300′ in all directions. The lenses 110 that are (horizontally) adjacent to each other are shown tilted in opposite directions (e.g., directed upwards or downwards).

In the example shown with 8 of the lenses 110, the opposite lens pairs (e.g., the opposite lens pair 110a-110a′, the opposite lens pair 110b-110b′, the opposite lens pair 110c-110c′ and the opposite lens pair 110d-110d′) may each be directed in the same direction. In an example, for the opposite lens pair 110a-110a′, both the lens 110a and the lens 110a′ may be tilted downwards. In another example, for the opposite lens pair 110b-110b′, both the lens 110b and the lens 110b′ may be tilted upwards. In yet another example, for the opposite lens pair 110c-110c′, both the lens 110c and the lens 110c′ may be tilted downwards. In still another example, for the opposite lens pair 110d-110d′, both the lens 110d and the lens 110d′ may be tilted upwards. The particular ones of the opposite lenses pairs that are tilted upwards and the particular ones of the opposite lens pairs that are tilted downwards may be varied according to the design criteria of a particular implementation.

In the tilted configuration of the omnidirectional camera 300′, the distance DNH may be determined using an equation EQ 38:

$${D}_{NH} = \sqrt{\begin{matrix}( 2 - \sqrt{2} ) {( \frac{B}{2} ( 1 + sin ( α ) ) + H cos ( α ) )}^{2} + \\ 4 {( - \frac{B}{2} cos ( α ) + ( H - T ) sin ( α ) )}^{2}\end{matrix}}$$

In the tilted configuration of the omnidirectional camera 300′, the distance DCH may be determined using an equation EQ 39:

$${D}_{CH} = \sqrt{\begin{matrix}{( \frac{B}{2} ( 1 + sin ( α ) ) + H cos ( α ) )}^{2} + \\ {( - \frac{B}{2} cos ( α ) + ( H - T ) sin ( α ) )}^{2}\end{matrix}}$$

In the tilted configuration of the omnidirectional camera 300′, the distance DOH may be determined using an equation EQ 40:

D_{OH}=B(1+sin(α))+2H cos(α))

Using the equations EQ 38, EQ 39 and EQ 40 with example numerical values of N=8, H=20 mm, B=25 mm, and α=45°, the distance DNH=27 mm (e.g., a smaller distance than the distance DNH in the non-tilted example shown in FIG. 22), DCH=36 mm (e.g., a smaller distance than the distance DCH in the non-tilted example shown in FIG. 22), and DOH=71 mm (e.g., a smaller distance than the distance DOH in the non-tilted example shown in FIG. 22). In some embodiments, the lenses 110 may be oriented such that the centers of projection 114 may be coplanar.

Referring to FIG. 24, a diagram illustrating an example embodiment with eight of the lenses 110 arranged around the periphery 120 of an omnidirectional camera 350 oriented to adjust (or configure) parallax effects and two vertically oriented lenses is shown. The opposite lens pair (e.g., one subset of the lenses) 110c-110c′ is shown as the vertically oriented lenses (e.g., the lenses 110 that are not arranged around the periphery 120). The omnidirectional camera 350 may have eight of the lenses 110 around the periphery 120. The subset of lenses 110a-110a′, subset of lenses 110b-110b′, subset of lenses 110d-110d′ and/or the subset of lenses 110e-110e′ are shown tilted in alternating directions around the periphery 120.

A direction 124c is shown. The direction 124a may be a direction above the omnidirectional camera 350. The direction 124c may be the optical axis of the lens 110c. A direction 124c′ is shown. The direction 124c′ may be a direction below the omnidirectional camera 350. The lenses 110 around the periphery 120 may be tilted towards the direction 124c or the direction 124c′. In the example shown, the lens 110a may be directed towards the direction 124c′ (e.g., downwards), the lens 110b may be directed towards the direction 124c (e.g., upwards), the lens 110d (not shown) may be directed towards the direction 124c′ (e.g., downwards), the lens 110e (not shown) may be directed towards the direction 124c (e.g., upwards), the lens 110a′ (not shown) may be directed towards the direction 124c′ (e.g., downwards), the lens 110b′ may be directed towards the direction 124c (e.g., upwards), the lens 110d′ may be directed towards the direction 124c′ (e.g., downwards) and the lens 110e′ may be directed towards the direction 124c (e.g., upwards). Each lens 110 in each opposite lens pair may be directed towards the same direction (e.g., the lenses 110b and 110b′ are both directed towards the direction 124c). The particular lens pairs that are directed in a particular direction may be varied according to the design criteria of a particular implementation.

A direction 160d′ is shown. The direction 160d′ may be a reference direction. The reference direction 160d′ may be a direction along a horizontal plane. A direction 160b is shown. The direction 160b may be a reference direction. The reference direction 160b may be a direction along a horizontal plane. A direction 124d′ is shown. The direction 124d′ may be a direction of the optical axis of the lens 110d′. The optical axis 124d′ may be directed towards the direction 124c′. A direction 124b is shown. The direction 124b may be a direction of the optical axis of the lens 110b. The optical axis 124b may be directed towards the direction 124c.

The angle α is shown between the direction 160d′ and the optical axis 124d′ of the lens 110d′. The angle α may be an amount of tilt (e.g., downward tilt) for the lenses 110. For example, the angle α may represent an amount of downward tilt (e.g., towards the direction 124c′) for the lenses 110d′, 110a, 110d and/or 110a′. In some embodiments, the value of the angle α may be different for each of the lenses 110 that are tilted downwards.

The angle θ is shown between the direction 160b and the optical axis 124b of the lens 110b. The angle θ may be an amount of tilt (e.g., upward tilt) for the lenses 110. For example, the angle θ may represent an amount of upward tilt (e.g., towards the direction 124c) for the lenses 110b, 110e′, 110b′ and/or 110e. In some embodiments, the value of the angle θ may be different for each of the lenses 110 that are tilted upwards.

The lenses 110 arranged around the periphery 120 may be alternately tilted towards opposite directions. In an example, the lens 110d′ is shown tilted towards the direction 124c′, in a counterclockwise direction around the periphery 120 the next lens 110e′ is shown tilted towards the direction 124c, in a counterclockwise direction around the periphery 120 the next lens 110a is shown tilted towards the direction 124c′, in a counterclockwise direction around the periphery 120 the next lens 110b is shown tilted towards the direction 124c, in a counterclockwise direction around the periphery 120 the next lens 110d (not visible in the perspective shown in FIG. 24) is tilted towards the direction 124c′, in a counterclockwise direction around the periphery 120 the next lens 110e′ (not visible in the perspective shown in FIG. 24) is tilted towards the direction 124c, in a counterclockwise direction around the periphery 120 the next lens 110a′ (not visible in the perspective shown in FIG. 24) is tilted towards the direction 124c′, in a counterclockwise direction around the periphery 120 the next lens 110b′ is shown tilted towards the direction 124c and in a counterclockwise direction around the periphery 120 the next lens may be the lens 120d′. The amount of tilt for each of the lenses is shown approximately equal. In some embodiments, each of the lenses 110 arranged around the periphery 120 may have a different amount of tilt.

Similar to the omnidirectional camera embodiment 300′, the distances DNH, DCH and DOH for the omnidirectional camera embodiment 350 may be calculated using the equations EQ 38, EQ 39 and EQ 40. The distance DCV for the vertical lenses 110c-110c′ may be calculated using an equation EQ 41:

D_{CV}=H+V

The distance DNV may be calculated using an equation EQ 42:

$${D}_{NV} = \sqrt{\begin{matrix}{( \frac{B}{2} ( 1 + sin ( α ) ) + H cos ( α ) )}^{2} + \\ {( ‖ \frac{B}{2} cos ( α ) - ( H - T ) sin ( α ) ‖ - ( H + V ) )}^{2}\end{matrix}}$$

The placement of the opposite lens pair 110c-110c′ may be selected according to the pre-determined purpose. In some embodiments, the lenses 110c-110c′ may be directed towards a particular direction of interest. In one example, the lenses 110c-110c′ may be arranged such that the distance DCV may be equivalent (or nearly equal) to the distance DCH (e.g., the 10 optical centers 114 of the lenses 110 may be arranged as a sphere having a radius equal to the distance DCH). In another example, the lenses 110c-110c′ may be arranged such that the distance DNV may be equal (or nearly equal) to the distance DNH. When the distance DNV is equal (or nearly equal) to the distance DNH the parallax between the closest neighboring lenses 110 may be the same regardless of a position of the lens 110 (e.g., on the vertical axis, or close to the horizontal plane).

In yet another example, the lenses 110c-110c′ may be arranged such that the distance DNV between the lenses 110c-110c′ and a closest one of the lenses 110 arranged around the periphery 120 is reduced (e.g., at a minimum value). The distance DNV may be at a minimum value when the optical center 114 of a vertical axis lens 110 is at the same vertical elevation as the optical center 114 of one of the closest neighboring lenses 110. A condition for when the distance DNV is at a minimum value may be when an equation EQ 43 is satisfied (e.g., where ∥.∥ denotes the absolute value):

V+H=∥(H−T)sin(α)−B/2·cos(α)∥

In still another example, the lenses 110c-110c′ may be arranged such that the distance V between the base 116c and the base 116c′ is a smallest possible value (e.g., to keep the vertical lenses 110c-110c′ as close as possible to the center of the lens rig 122. In the arrangement with 8 lenses arranged around the periphery 120, the bases 116c-116c′ may have enough room to be touching back-to-back (e.g., the distance V is zero). For example, the space between the bases (e.g., 116a-116a′, 116b-116b′ 116d-116d′ and/or 116e-116e′) of the lenses (e.g., 110a-110a′, 110b-110b′ 110d-110d′ and/or 110e-110e′) arranged around the periphery 120 may be large enough for the bases 116c-116c′ to fit. For example, the distance DOH may be large enough for the bases 116c-116c′ to entirely fit between the lenses 110 arranged around the periphery 120. The base 116c may be in contact with the base 116c′ (e.g., partially touching each other at one or more points or flush against the entire area of each other).

Depending on a physical occupancy of the lens barrels 112, the bases 116 and/or the angle (e.g., α and/or θ) the lenses 110 are tilted, not all possibilities for physical arrangement of the lenses 110 may be physically realized. In an example, the arrangement where the distance DNV between the lenses 110c-110c′ and a closest one of the lenses 110 arranged around the periphery 120 is reduced (e.g., at a minimum value) may be preferred but may not be achieved when the optical centers 114 of the lenses 110 arranged around the periphery 120 are coplanar on the horizontal plane. The optical centers 114 of the lens 110 arranged around the periphery 120 may be coplanar on the horizontal plane when an equation is EQ 44 is satisfied:

(H−T)sin(α)−B/2·cos(α)=0

The equation EQ 44 may be satisfied when the distance V is opposite to the distance H.

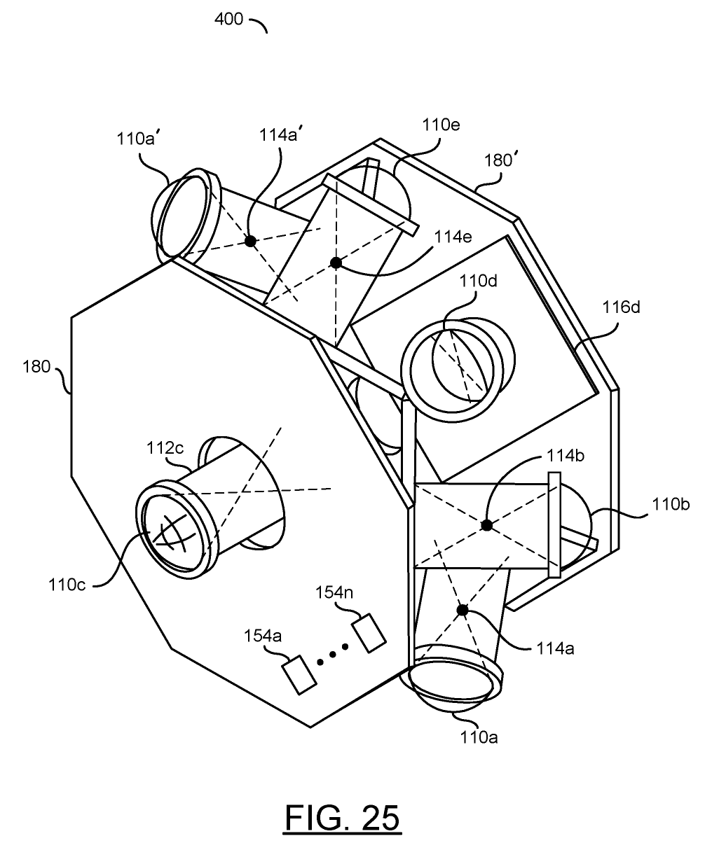

Referring to FIG. 25, a diagram illustrating an example embodiment with eight of the lenses 110 arranged around the periphery 120 of an omnidirectional camera 400 oriented to adjust (or configure) parallax effects and two vertically oriented lenses passing through holes of circuit boards is shown. The omnidirectional camera embodiment 400 may have a similar arrangement of the lenses 110 as the omnidirectional camera embodiment 300. The circuit board 180 is shown located at one end of the omnidirectional camera embodiment 400. The circuit board 180′ is shown at another end of the omnidirectional camera embodiment 400.

The circuit board 180 is shown having the hole 182. The hole 182 may allow the lens 110c to fit through the circuit board 180. Similarly, the circuit board 180′ may have the hole 182 to allow the lens 110c′ to fit through the circuit board 180′. The hole 182 may enable the lenses that are not arranged around the periphery 120 (e.g., the opposite lens pair 110c-110c′) to capture the environment surrounding the omnidirectional camera 400 without being obstructed by the circuit board 180 (or the circuit board 180′). A size of the circuit boards 180-180′ may be scaled and/or shaped to accommodate a size, arrangement and/or number of the lenses 110.

The circuit boards 180-180′ may implement the hole 182 in order to enable a placement of the top and bottom lenses 110c-110c′ while keeping the lenses 110c-110c′ close to the lenses 110 arranged around the periphery 120. Implementing the lenses 110c-110c′ (e.g., the top and bottom lenses) may enable more coverage of the environment surrounding the omnidirectional camera 400. As the number of the lenses 110 arranged around the periphery 120 is increased, the benefit of implementing the top lens 110c and/or the bottom lens 110c′ may be reduced (e.g., the 8 lenses 110 arranged around the periphery 120 may provide similar coverage).

Depending on the pre-determined purpose for the omnidirectional camera 100, the entanglement of the lenses 110 may be used to control (e.g., not necessarily minimize) the parallax effects. In some embodiments, entangling the lenses 110 may result in a reduction of a size of the assembly of the omnidirectional camera 100 (e.g., the lenses 110 and the frame 108).

Generally, the distances between the centers of projection 114 of the lenses 110 arranged around the periphery 120 may result in a greater change to the parallax effects compared to the centers of projection 114 of the vertically oriented lenses 110.

The lenses 110 may be oriented (e.g., tilted and/or entangled) such that the centers of projection 114 of the lenses 110 arranged around the periphery 120 are coplanar. Arranging the lenses 110 around the periphery 120 to have the centers of projection 114 be coplanar may avoid getting vertical parallax between the lenses 110. For example, if the centers of projection 114 are coplanar and the centers of projection 114 for the neighboring lenses 110 arranged around the periphery 120 are approximately 6 cm apart, the omnidirectional camera 100 may have a compact size. The distance DCH for the various embodiments of the omnidirectional camera 100 may not be an exact measurement of the radius of the omnidirectional camera 100, but may be used as an approximation. The approximation using the distance DCH may provide an indication about benefits of various orientations with respect to a compactness of the omnidirectional camera 100.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. An apparatus comprising:
a plurality of lenses arranged to provide coverage for a spherical field of view of a scene surrounding the apparatus; and
a frame configured to hold (A) a first subset of said plurality of lenses, (B) a second subset of said plurality of lenses and (C) a third subset of said plurality of lenses, wherein (i) at least one of said lenses in said first subset and at least one of said lenses in said second subset are neighboring lenses arranged around a periphery of said apparatus, (ii) at least one of said lenses in said third subset and at least one of said lenses in said first subset or said second subset are neighboring lenses and (iii) at least two of said neighboring lenses are oriented to adjust parallax effects for a pre-determined purpose when said spherical field of view is recorded using said plurality of lenses.

2. The apparatus according to claim 1, wherein (i) said neighboring lenses arranged around said periphery are horizontally neighboring lenses and (ii) each lens of said third subset is vertically neighboring said first subset of lenses and said second subset of said lenses.

3. The apparatus according to claim 2, wherein said third subset of said lenses comprises at least one of said lenses configured to point in a first direction.

4. The apparatus according to claim 3, wherein (i) a circuit board is configured having a hole large enough to fit at least one of said lenses of said third subset and (ii) said lens pointing in said first direction is configured to fit through said hole in said circuit board.

5. The apparatus according to claim 3, wherein each of said lenses arranged around said periphery are oriented to be alternately tilted (i) towards said first direction and (ii) towards a second direction that is opposite to said first direction.

6. The apparatus according to claim 5, wherein optical center points corresponding to each of said lenses arranged around said periphery are coplanar.

7. The apparatus according to claim 3, wherein a first distance between an optical center point of each of said lenses of said third subset and a center point of said apparatus is equal to a second distance between an optical center point of each of said lenses of said first subset and said center point of said apparatus.

8. The apparatus according to claim 3, wherein a first distance between an optical center point of one of said lenses of said third subset and an optical center point of one of said lenses of said first subset is equal to a second distance between said optical center point of one of said lenses of said first subset and an optical center point of one of said lenses of said second subset.

9. The apparatus according to claim 3, wherein an optical center point of one of said lenses of said third subset is at a same vertical elevation as an optical center point of one of the closest lenses of said vertically neighboring lenses.

10. The apparatus according to claim 3, wherein (i) said third subset further comprises a second lens pointing in a second direction that is opposite to said first direction and (ii) a base of said lens of said third subset pointing in said first direction is in contact with a base of said second lens of said third subset.

11. The apparatus according to claim 3, wherein (i) said third subset further comprises a second lens pointing in a second direction that is opposite to said first direction and (ii) a base of said lens of said third subset pointing in said first direction and a base of said second lens of said third subset is in contact with at least one of a base of one lens of said first subset and a base of one lens of said second subset.

12. The apparatus according to claim 1, wherein said arrangement of said lenses is configured to reduce a size of said apparatus.

13. The apparatus according to claim 1, wherein said parallax effects are adjusted based on distances between optical center points of said lenses in said first subset and said second subset.

14. The apparatus according to claim 13, wherein said parallax effects are further adjusted based on distances between optical center points of said lenses in said third subset and said optical center points of said lenses in (a) said first subset or (b) said second subset.

15. The apparatus according to claim 13, wherein said distances between said optical center points of said lenses in said first subset and said second subset are reduced.

16. The apparatus according to claim 15, wherein said pre-determined purpose is generating a monoscopic rendering of said spherical field of view.

17. The apparatus according to claim 13, wherein (i) said distances between said optical center points of said lenses in said first subset and said second subset are selected to implement a stereoscopic baseline and (ii) said pre-determined purpose is generating stereoscopic renderings of said spherical field of view.

18. The apparatus according to claim 17, wherein one of said stereoscopic renderings is configured for a first spherical video for a left eye of a user and another of said stereoscopic renderings is configured for a second spherical video for a right eye of said user.

19. The apparatus according to claim 1, wherein (i) said third subset of said lenses is arranged around said periphery of said apparatus and (ii) said lenses arranged around said periphery of said apparatus are oriented to be alternately tilted (i) towards a first direction and (ii) towards a second direction that is opposite to said first direction.

20. The apparatus according to claim 19, wherein center points corresponding to each of said lenses arranged around said periphery are coplanar.
